(19) United States
(12) Patent Application Publication
(10) Pub. No.: US 2021/0396958 A1
(43) Pub. Date: Dec. 23, 2021

(54) OPTICAL SYSTEM, LENS MODULE, AND ELECTRONIC DEVICE

(71) Applicant: JIANGXI JINGCHAO OPTICAL CO., LTD., Nanchang (CN)

(72) Inventors: Xuwen DANG, Nanchang (CN); Binbin LIU, Nanchang (CN); Ming LI, Nanchang (CN); Hairong ZOU, Nanchang (CN)

(21) Appl. No.: 17/465,913

(22) Filed: Sep. 3, 2021

Related U.S. Application Data
(63) Continuation of application No. PCT/CN2020/083346, filed on Apr. 3, 2020.

(51) Int. Cl. G02B 9/62; G02B 13/00

(52) U.S. Cl. CPC G02B 9/62; G02B 13/0045

(57) ABSTRACT

An optical system, a lens module, and an electronic device are provided. The optical system includes a first lens, a second lens, a third lens, a fourth lens, a fifth lens, and a sixth lens. The fifth lens has an object-side surface and an image-side surface which are both aspheric surfaces. At least one of the object-side surface and the image-side surface of the fifth lens has at least one inflection point. The sixth lens has an object-side surface and an image-side surface which are both aspheric surfaces. At least one of the object-side surface and the image-side surface of the sixth lens has at least one inflection point.

### CROSS-REFERENCE TO RELATED APPLICATIONS

The present application is a continuation of International Application No. PCT/CN2020/083346, filed on Apr. 3, 2020, the disclosure of which is hereby incorporated by reference in its entirety.

### TECHNICAL FIELD

This disclosure relates to the technical field of optical imaging, and in particular to an optical system, a lens module, and an electronic device.

### BACKGROUND

The manufacturing technology of electronic products such as smartphones and tablets is constantly developing, and the lens, which is one of the important basic parts of image data collection, is also undergoing diversified development. In recent years, the development trend of the lens has gradually changed to large aperture, high resolution, and good image quality.

However, in the traditional lens, spacing between lenses is large, the F-number and resolution are difficult to meet the market demand. In addition, the lens and mechanism are easy to produce stray light that is difficult to eliminate, which brings great troubles to the production of optical imaging lenses.

### SUMMARY

The disclosure aims to provide an optical system, a lens module, and an electronic device, so as to solve the above technical problems.

To this end, the disclosure provides the following technical solutions.

In a first aspect, an optical system is provided. The optical system includes in order from an object side to an image side along an optical axis: a first lens with a positive refractive power, the first lens having an object-side surface which is convex; a second lens with a negative refractive power, the second lens having an image-side surface which is concave near the optical axis; a third lens with a refractive power, the third lens having an object-side surface which is convex near the optical axis; a fourth lens with a refractive power, the fourth lens having an object-side surface and an image-side surface which are aspheric surfaces; a fifth lens with a positive refractive power, the fifth lens having an object-side surface which is concave near a periphery, the object-side surface and an image-side surface of the fifth lens being aspheric surfaces, and at least one of the object-side surface and the image-side surface of the fifth lens having at least one inflection point; and a sixth lens with a negative refractive power, the sixth lens having an object-side surface which is convex near the optical axis and an image-side surface which is concave near the optical axis, the object-side surface and the image-side surface of the sixth lens being aspheric surfaces, and at least one of the object-side surface and the image-side surface of the sixth lens having at least one inflection point. By properly configuring surface profiles and refractive powers of the first lens to the sixth lens, the optical system of the disclosure can satisfy the requirements of high resolution, large aperture, and good image quality, while maintaining a compact structure, which can effectively reduce impact of inside stray light.

In some implementations, the optical system satisfies the following expression: |SAG41|/|SAG42|<20.0, where SAG41 represents a sagittal depth at a maximum effective aperture of the object-side surface of the fourth lens, and SAG42 represents a sagittal depth at a maximum effective aperture of the image-side surface of the fourth lens. The change in sagittal depth of the fourth lens may correspondingly change the surface profile, so that the surface profile is more suitable for aberration correction. When the optical system satisfies the above expression, the fourth lens does not have excessive surface inclination, which facilitates processing and forming of the lens. Moreover, the ability of aberration correction of the optical system can be improved, resolution can be enhanced, and the lens is easy to be manufactured.

In some implementations, the optical system satisfies the following expression: 2.2<(CT2+CT3+CT4)/(CT23+CT34) [symbol] 8.5, where CT2 represents a thickness of the second lens on the optical axis, CT3 represents a thickness of the third lens on the optical axis, CT4 represents a thickness of the fourth lens on the optical axis, CT23 represents a distance from the image-side surface of the second lens to the object-side surface of the third lens on the optical axis, and CT34 represents a distance from an image-side surface of the third lens to the object-side surface of the fourth lens on the optical axis. When the optical system satisfies the above expression, an average refractive index of the second lens, the third lens, the forth lens, and the air gap is reconciled properly, the center thickness and the edge thickness of each of the second lens, the third lens, and the fourth lens are increased, and the air gaps between the lenses are compressed. In this way, the overall compactness of the group of lenses can be improved to some extent, which facilitates to decrease a deflection angle of light in refraction, so as to reduce tolerance sensitivity.

In some implementations, the optical system satisfies the following expression: 0.35<f/|f3|+f/|f4|<0.8, where f represents an effective focal length of the optical system, f3 represents an effective focal length of the third lens, and f4 represents an effective focal length of the fourth lens. The change of refractive powers of the third lens and the fourth lens can balance distortion and coma generated by the front lens group. The third lens and the fourth lens do not introduce large aberration, so that surface profiles of the third lens and the fourth lens can be flexibly configured to improve resolution of the optical system. When the optical system satisfies the above expression, the refractive powers of the third lens and the fourth lens are properly distributed, so that the deflection angle of edge light can be well controlled; at the same time, illumination of the imaging surface can be increased and stability of the optical system can be improved.

In some implementations, the optical system satisfies the following expression: |SAG61/CT6| [symbol] 1.8, where SAG61 represents a sagittal depth at an effective aperture of the object-side surface of the sixth lens, and CT6 represents a thickness of the sixth lens on the optical axis. When the optical system satisfies the above expression, the change in the sagittal depth and the surface profile of the sixth lens provides different possibilities for distribution of refractive power of the lens close to the imaging surface and perpendicular to the optical axis, and also make it possible to better guide light to avoid an incident angle of the light incident onto the imaging surface from being too large, thus well matching with the high-resolution photosensitive chip. At the same time, the sixth lens can effectively balance the aberration generated by the front lens group, which is more conducive to improve the image quality of the optical system.

In some implementations, the optical system satisfies the following expression: 0.2<∥R51|−|R52∥/(|R51|+|R52|) [symbol] 0.8, where R51 represents a radius of curvature of the object-side surface of fifth lens at the optical axis, and R52 represents a radius of curvature of the image-side surface of fifth lens at the optical axis. When the optical system satisfies the above expression, the fifth lens has at least one inflection point and is aspheric. The thickness of the lens can be compressed, so as to effectively improve aberration generated by the front lens group and further improve resolution.

In some implementations, the optical system satisfies the following expression: f123/|f56| [symbol] 0.36, where f123 represent an effective total focal length of the first lens, the second lens, and the third lens, and f56 represents an effective total focal length of the fifth lens and the sixth lens. The rationality of thickness and gap is directly related to the difficulty of lens forming and manufacturing. When the optical system satisfies the above expression, the center thickness and edge thickness of each of the first lens, the second lens, and the third lens can be kept appropriate, and the distribution of refractive powers is reasonable. The rationality and compactness of the lens structure can be effectively improved, which facilitates compression of the total length of the optical system and balance of the image quality, thus reducing difficulty of arrangement and assembly of the lenses.

In some implementations, the optical system satisfies the following expression: 0.60 mm<(CT1+BF)/FNO [symbol] 0.85 mm, where CT1 represents a thickness of the first lens on the optical axis, BF represents an axial distance from a farthest point on the image-side surface of the sixth lens to an imaging surface, and FNO represents an F-number of the optical system. The reasonable configuration of BF can better satisfy the matching between the optical system and the chip. When the optical system satisfies the above expression, the first lens can maintain a good thickness and surface profile at a small aperture, which is helpful to reduce the risk of lens molding; in addition, it also provides support for the increase of the angle of view.

In some implementations, the optical system satisfies the following expression: 6.1<|f3|/n3<22.7, where f3 represents an effective focal length of the third lens, and n3 represents a refractive index of a material of the third lens under a wavelength of 587.6 nm. When the optical system satisfies the above expression, the refractive powers of the third lens and other lenses can be reasonably distributed, so that the optical system supports aberration balance and image quality improvement under different materials. Also, the air gaps between the second lens, the third lens, and the fourth lens can be easily compressed, thereby improving the compactness of the optical system and avoiding the influence of stray light.

In some implementations, the optical system satisfies the following expression: ET34/Img [symbol] 0.12, where ET34 represents an axial distance from a point where the image-side surface of the third lens has a maximum effective aperture to a point where the object-side surface of the fourth lens has a maximum effective aperture, and ImgH represents half of a diagonal length of an effective imaging region on an imaging surface of the optical system. ImgH determines the size of the electronic photosensitive chip. The larger the ImgH, the larger the maximum size of the electronic photosensitive chip that can be supported. When the optical system satisfies the above expression, the optical system can support the electronic photosensitive chip with higher resolution. At the same time, the effective aperture distance between the third lens and the fourth lens can be effectively controlled, so that the deflection angle of edge light is relatively small, which is beneficial to reduce the tolerance sensitivity of the optical system, thereby improving the performance of edge field of view.

In a second aspect, a lens module is provided. The lens module includes a lens barrel, an electronic photosensitive element, and the optical system of any of implementations of the first aspect. The first lens to the sixth lens of the optical system are installed in the lens barrel. The electronic photosensitive element is disposed at the image side of the optical system and configured to convert the light of an object incident to the electronic photosensitive element through the first lens to the sixth lens into an electric signal of an image. By installing the optical system in the lens module, the lens module can meet the requirements of high resolution, large aperture, and good image quality while maintaining a compact structure, effectively reducing the influence of internal stray light.

In a third aspect, an electronic device is provided. The electronic device includes a housing and the lens module of the second aspect. The lens module is disposed in the housing. By setting the lens module of the second aspect in the electronic device, the electronic device can meet the requirements of high resolution, large aperture, and good image quality while maintaining a compact structure, effectively reducing the influence of internal stray light.

### BRIEF DESCRIPTION OF THE DRAWINGS

In order to more clearly describe the technical solutions in the implementations of the present disclosure or the prior art, the following will briefly introduce the drawings that need to be used in the description of the implementations or the prior art. Obviously, the drawings in the following description are only some implementations of the present disclosure. For those of ordinary skill in the art, other drawings can be obtained based on these drawings without creative work.

FIG. 1a is a schematic structural diagram of an optical system according to an embodiment of the disclosure.

FIG. 1b illustrates a longitudinal spherical aberration curve, an astigmatic curve, and a distortion curve according to the embodiment of FIG. 1a.

FIG. 2a is a schematic structural diagram of an optical system according to an embodiment of the disclosure.

FIG. 2b illustrates a longitudinal spherical aberration curve, an astigmatic curve, and a distortion curve according to the embodiment of FIG. 2a.

FIG. 3a is a schematic structural diagram of an optical system according to an embodiment of the disclosure.

FIG. 3b illustrates a longitudinal spherical aberration curve, an astigmatic curve, and a distortion curve according to the embodiment of FIG. 3a.

FIG. 4a is a schematic structural diagram of an optical system according to an embodiment of the disclosure.

FIG. 4b illustrates a longitudinal spherical aberration curve, an astigmatic curve, and a distortion curve according to the embodiment of FIG. 4a.

FIG. 5a is a schematic structural diagram of an optical system according to an embodiment of the disclosure.

FIG. 5b illustrates a longitudinal spherical aberration curve, an astigmatic curve, and a distortion curve according to the embodiment of FIG. 5a.

FIG. 6a is a schematic structural diagram of an optical system according to an embodiment of the disclosure.

FIG. 6b illustrates a longitudinal spherical aberration curve, an astigmatic curve, and a distortion curve according to the embodiment of FIG. 6a.

FIG. 7a is a schematic structural diagram of an optical system according to an embodiment of the disclosure.

FIG. 7b illustrates a longitudinal spherical aberration curve, an astigmatic curve, and a distortion curve according to the embodiment of FIG. 7a.

### DETAILED DESCRIPTION

The following will clearly and completely describe technical solutions of implementations with reference to the accompanying drawings. Apparently, implementations described herein are merely some rather than all implementations of the disclosure. Based on the implementations described herein, all other implementations obtained by those of ordinary skill in the art without creative effort shall fall within the protection scope of the disclosure.

In implementations of this disclosure, a lens module is provided. The lens module includes a lens barrel, an electronic photosensitive element, and the optical system provided in this disclosure. A plurality of lenses of the optical system, from the first lens to the sixth lens, are installed within the lens barrel. The electronic photosensitive element disposed at an image side of the optical system is configured to convert a ray, which goes through from the first lens to the sixth lens and is incident on the electronic photosensitive element, into an electrical signal of an image. The photosensitive element may be a complementary metal oxide semiconductor (CMOS) or a charge-coupled device (CCD). The lens module may be an independent camera of a digital camera, or an imaging module integrated on the electronic device such as a smart phone. By installing the first lens to the sixth lens of the optical system in the lens module and properly configuring the surface profiles and refractive powers of the first lens to the sixth lens, the lens module provide in this disclosure can meet the requirements of high resolution, large aperture, and good image quality while maintaining a compact structure, effectively reducing the influence of internal stray light.

In implementations of this disclosure, an electronic device is provided. The electronic device includes a housing and a lens module provided in this disclosure. The lens module and the electronic photosensitive element are disposed within the housing. The electronic device may be a smart phone, a personal digital assistant (PDA), a tablet computer, a smart watch, a drone, an electronic book viewer, a drive recorder, a wearable device, and the like. By installing the lens module of the second aspect in the electronic device, the electronic device can meet the requirements of high resolution, large aperture, and good image quality while maintaining a compact structure, effectively reducing the influence of internal stray light.

In implementations of this disclosure, an optical system is provided. The optical system includes in order from an object side to an image side along an optical axis: a first lens, a second lens, a third lens, a fourth lens, a fifth lens, and a sixth lens. There may be an air gap between any two adjacent lenses.

The six lenses have shapes and structures as follows. The first lens with a positive refractive power has an object-side surface which is convex. The second lens with a negative refractive power has an image-side surface which is concave near the optical axis. The third lens with a refractive power has an object-side surface which is convex near the optical axis. The fourth lens with a refractive power has an object-side surface and an image-side surface which are both aspheric. The fifth lens with a positive refractive power has an object-side surface which is concave near the periphery. Both the object-side surface and an image-side surface of the fifth lens are aspheric surfaces. At least one of the object-side surface and the image-side surface of the fifth lens has at least one inflection point. The sixth lens with a negative refractive power has an object-side surface which is convex near the optical axis and an image-side surface which is concave near the optical axis. Both the object-side surface and the image-side surface of the sixth lens are aspheric surfaces. At least one of the object-side surface and the image-side surface of the sixth lens has at least one inflection point. By properly configuring surface profiles and refractive powers of the first lens to the sixth lens, the optical system of the disclosure can satisfy the requirements of high resolution, large aperture, and good image quality, while maintaining a compact structure, which can effectively reduce impact of inside stray light.

In some implementations, the optical system satisfies the following expression: |SAG41|/|SAG42|<20.0, where SAG41 represents a sagittal depth at a maximum effective aperture of the object-side surface of the fourth lens, and SAG42 represents a sagittal depth at a maximum effective aperture of the image-side surface of the fourth lens. The change in sagittal depth of the fourth lens may correspondingly change the surface profile, so that the surface profile is more suitable for aberration correction. When the optical system satisfies the above expression, the fourth lens does not have excessive surface inclination, which facilitates processing and forming of the lens. Moreover, the ability of aberration correction of the optical system can be improved, resolution can be enhanced, and the lens is easy to be manufactured.

In some implementations, the optical system satisfies the following expression: 2.2<(CT2+CT3+CT4)/(CT23+CT34) [symbol] 8.5, where CT2 represents a thickness of the second lens on the optical axis, CT3 represents a thickness of the third lens on the optical axis, CT4 represents a thickness of the fourth lens on the optical axis, CT23 represents a distance from the image-side surface of the second lens to the object-side surface of the third lens on the optical axis, and CT34 represents a distance from an image-side surface of the third lens to the object-side surface of the fourth lens on the optical axis. When the optical system satisfies the above expression, an average refractive index of the second lens, the third lens, the forth lens, and the air gap is reconciled properly, the center thickness and the edge thickness of each of the second lens, the third lens, and the fourth lens are increased, and the air gaps between the lenses are compressed. In this way, the overall compactness of the group of lenses can be improved to some extent, which facilitates to decrease a deflection angle of light in refraction, so as to reduce tolerance sensitivity.

In some implementations, the optical system satisfies the following expression: 0.35<f/|f3|+f/|f4|<0.8, where f represents an effective focal length of the optical system, f3 represents an effective focal length of the third lens, and f4 represents an effective focal length of the fourth lens. The change of refractive powers of the third lens and the fourth lens can balance distortion and coma generated by the front lens group. The third lens and the fourth lens do not introduce large aberration, so that surface profiles of the third lens and the fourth lens can be flexibly configured to improve resolution of the optical system. When the optical system satisfies the above expression, the refractive powers of the third lens and the fourth lens are properly distributed, so that the deflection angle of edge light can be well controlled; at the same time, illumination of the imaging surface can be increased and stability of the optical system can be improved.

In some implementations, the optical system satisfies the following expression: |SAG61/CT6| [symbol] 1.8, where SAG61 represents a sagittal depth at an effective aperture of the object-side surface of the sixth lens, and CT6 represents a thickness of the sixth lens on the optical axis. When the optical system satisfies the above expression, the change in the sagittal depth and the surface profile of the sixth lens provides different possibilities for distribution of refractive power of the lens close to the imaging surface and perpendicular to the optical axis, and also make it possible to better guide light to avoid an incident angle of the light incident onto the imaging surface from being too large, thus well matching with the high-resolution photosensitive chip. At the same time, the sixth lens can effectively balance the aberration generated by the front lens group, which is more conducive to improve the image quality of the optical system.

In some implementations, the optical system satisfies the following expression: 0.2<∥R51|−|R52∥/(|R51|+|R52|) [symbol] 0.8, where R51 represents a radius of curvature of the object-side surface of fifth lens at the optical axis, and R52 represents a radius of curvature of the image-side surface of fifth lens at the optical axis. When the optical system satisfies the above expression, the fifth lens has at least one inflection point and is aspheric. The thickness of the lens can be compressed, so as to effectively improve aberration generated by the front lens group and further improve resolution.

In some implementations, the optical system satisfies the following expression: f123/|f56| [symbol] 0.36, where f123 represent an effective total focal length of the first lens, the second lens, and the third lens, and f56 represents an effective total focal length of the fifth lens and the sixth lens. The rationality of thickness and gap is directly related to the difficulty of lens forming and manufacturing. When the optical system satisfies the above expression, the center thickness and edge thickness of each of the first lens, the second lens, and the third lens can be kept appropriate, and the distribution of refractive powers is reasonable. The rationality and compactness of the lens structure can be effectively improved, which facilitates compression of the total length of the optical system and balance of the image quality, thus reducing difficulty of arrangement and assembly of the lenses.

In some implementations, the optical system satisfies the following expression: 0.60 mm<(CT1+BF)/FNO [symbol] 0.85 mm, where CT1 represents a thickness of the first lens on the optical axis, BF represents an axial distance from a farthest point on the image-side surface of the sixth lens to an imaging surface, and FNO represents an F-number of the optical system. The reasonable configuration of BF can better satisfy the matching between the optical system and the chip. When the optical system satisfies the above expression, the first lens can maintain a good thickness and surface profile at a small aperture, which is helpful to reduce the risk of lens molding; in addition, it also provides support for the increase of the angle of view.

In some implementations, the optical system satisfies the following expression: 6.1<|f3|/n3<22.7, where f3 represents an effective focal length of the third lens, and n3 represents a refractive index of a material of the third lens under a wavelength of 587.6 nm. When the optical system satisfies the above expression, the refractive powers of the third lens and other lenses can be reasonably distributed, so that the optical system supports aberration balance and image quality improvement under different materials. Also, the air gaps between the second lens, the third lens, and the fourth lens can be easily compressed, thereby improving the compactness of the optical system and avoiding the influence of stray light.

In some implementations, the optical system satisfies the following expression: ET34/Img [symbol] 0.12, where ET34 represents an axial distance from a point where the image-side surface of the third lens has a maximum effective aperture to a point where the object-side surface of the fourth lens has a maximum effective aperture, and ImgH represents half of a diagonal length of an effective imaging region on an imaging surface of the optical system. ImgH determines the size of the electronic photosensitive chip. The larger the ImgH, the larger the maximum size of the electronic photosensitive chip that can be supported. When the optical system satisfies the above expression, the optical system can support the electronic photosensitive chip with higher resolution. At the same time, the effective aperture distance between the third lens and the fourth lens can be effectively controlled, so that the deflection angle of edge light is relatively small, which is beneficial to reduce the tolerance sensitivity of the optical system, thereby improving the performance of edge field of view.

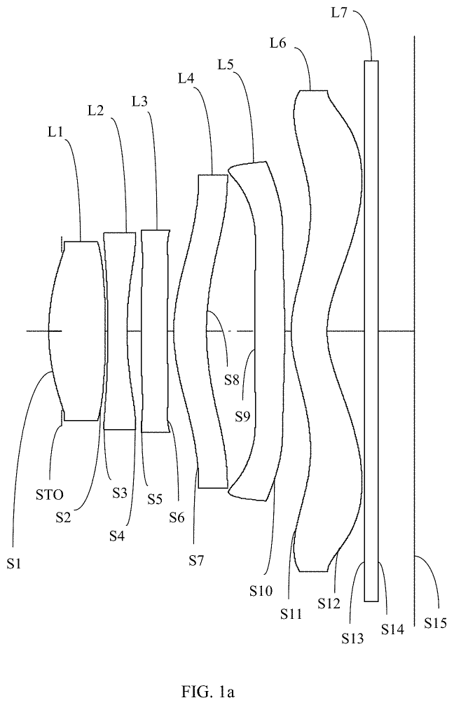

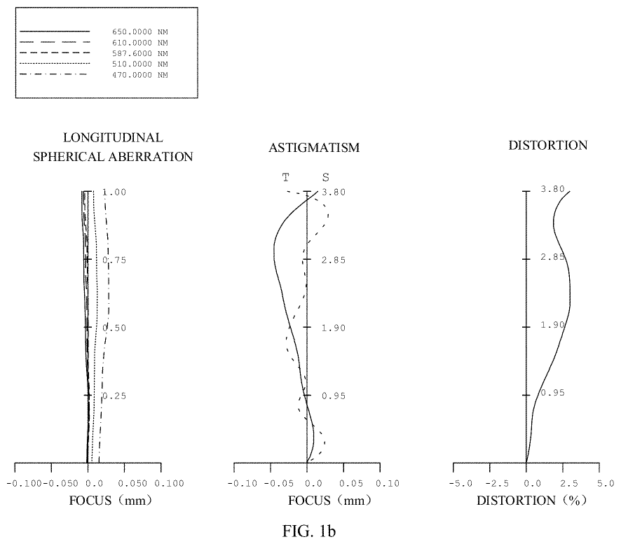

Referring to FIG. 1a and FIG. 1b, an optical system of this embodiment includes in order from an object side to an image side along an optical axis:

a first lens L1 with a positive refractive power, the first lens L1 having an object-side surface S1 which is convex both near the optical axis and near the periphery and an image-side surface S2 which is convex both near the optical axis and near the periphery;

a second lens L2 with a negative refractive power, the second lens L2 having an object-side surface S3 which is concave both near the optical axis and near the periphery and an image-side surface S4 which is concave near the optical axis and convex near the periphery;

a third lens L3 with a negative refractive power, the third lens L3 having an object-side surface S5 which is convex near the optical axis and concave near the periphery and an image-side surface S6 which is concave both near the optical axis and near the periphery;

a fourth lens L4 with a positive refractive power, the fourth lens L4 having an object-side surface S7 which is convex both near the optical axis and near the periphery and an image-side surface S8 which is concave both near the optical axis and near the periphery;

a fifth lens L5 with a positive refractive power, the fifth lens L5 having an object-side surface S9 which is concave both near the optical axis and near the periphery and an image-side surface S10 which is convex both near the optical axis and near the periphery; and

a sixth lens L6 with a negative refractive power, the sixth lens L6 having an object-side surface S11 which is convex both near the optical axis and near the periphery and an image-side surface S12 which is concave both near the optical axis and near the periphery.

The first lens L1 to the sixth lens L6 are made of plastic.

In addition, the optical system further includes a stop STO, an infrared filter L7, and an imaging surface S15. The stop STO is disposed at a side of the first lens L1 away from the second lens L2 and configured to control the amount of incident light. In other embodiments, the stop STO may also be disposed between two lenses or on other lens. The infrared filter L7 is disposed at the image side of the sixth lens L6. The infrared filter L7 has an object-side surface S13 and an image-side surface S14. The infrared filter L7 is used to filter out the infrared light, so that light incident to the imaging surface S15 is visible light which has a wavelength of 380 nm-780 nm. The infrared filter L7 is made of glass and the glass may be coated. The imaging surface S15 is a plane where an image is formed after the light of a photographed object passes through the optical system.

Table 1a shows characteristics of the optical system of this embodiment, where the data is obtained under a wavelength of 587.6 nm, and the Y radius, thickness, and focal length are measured in millimeters (mm).

TABLE 1a
Embodiment of FIG. 1a
f = 4.33 mm, FNO = 2.13, FOV = 78.23°, TTL = 5.6 mm

| Surface | Surface | Surface | | | | Refractive | Abbe | Focal |
|---|---|---|---|---|---|---|---|---|
| number | name | type | Y radius | thickness | material | index | number | length |
| Object surface | | spheric | infinity | infinity | | | | |
| STO | Stop | spheric | infinity | −0.196 | | | | |
| S1 | First | aspheric | 2.250 | 0.860 | plastic | 1.545 | 55.912 | 3.87 |
| S2 | lens | aspheric | −29.689 | 0.039 | | | | |
| S3 | Second | aspheric | −37.930 | 0.300 | plastic | 1.661 | 20.412 | −5.73 |
| S4 | lens | aspheric | 4.257 | 0.216 | | | | |
| S5 | Third | aspheric | 202.898 | 0.400 | plastic | 1.636 | 23.785 | −36.77 |
| S6 | lens | aspheric | 21.078 | 0.100 | | | | |
| S7 | Fourth | aspheric | 1.855 | 0.500 | plastic | 1.545 | 55.912 | 8.51 |
| S8 | lens | aspheric | 2.793 | 0.743 | | | | |
| S9 | Fifth | aspheric | −30.146 | 0.455 | plastic | 1.545 | 55.912 | 60.24 |
| S10 | lens | aspheric | −15.812 | 0.100 | | | | |
| S11 | Sixth | aspheric | 1.206 | 0.550 | plastic | 1.535 | 55.796 | −121.78 |
| S12 | lens | aspheric | 0.996 | 0.575 | | | | |
| S13 | Infrared | spheric | infinity | 0.210 | glass | 1.517 | 64.167 | |
| S14 | filter | spheric | infinity | 0.552 | | | | |
| S15 | Imaging | spheric | infinity | 0.000 | | | | |
| | surface | | | | | | | |

In this table, f represents an effective focal length of the optical system, FNO represents an F-number of the optical system, FOV represents an angle of view of the optical system, and TTL represents a distance on the optical axis from the object-side surface of the first lens to the imaging surface of the optical system.

In this embodiment, for each of the first lens L1 to the sixth lens L6, the object-side surface and the image-side surface are both aspheric surfaces. The surface profiles x of respective aspheric surfaces can be defined by but is not limited to the following equation:

$$x = \frac{{ch}^{2}}{1 + \sqrt{1 - ( k + 1 ) {c}^{2} {h}^{2}}} + \sum {Aih}^{i} .$$

Where x represents a sagittal depth from a position on the aspheric surface of a height h along the optical axis to a vertex of the aspheric surface; c represents a paraxial curvature of the aspheric surface, c=1/R (that is, the paraxial curvature c is a reciprocal of the Y radius R in Table 1a); k represents a conic coefficient; Ai represents a correction coefficient of order i of the aspheric surface. Table 1b illustrates the high-order coefficients A4, A6, A8, A10, A12, A14, A16, A18, and A20 which can be used in respective aspheric surfaces S1-S16 of this embodiment.

TABLE 1b
Embodiment of FIG. 1a
Aspheric coefficients

| Surface | | | | | | |
|---|---|---|---|---|---|---|
| number | S1 | S2 | S3 | S4 | S5 | S6 |
| K | −1.9955E+00 | 5.4123E+00 | −2.2561E+01 | −2.5518E+01 | −9.9000E+01 | 9.9000E+01 |
| A4 | 4.2458E−03 | −1.7249E−02 | 1.8993E−02 | 1.2722E−01 | 1.7886E−01 | 3.5116E−02 |
| A6 | 5.4707E−02 | −6.7510E−01 | −8.1888E−01 | −5.0738E−01 | −5.2651E−01 | −1.5600E−01 |
| A8 | −2.7929E−01 | 2.8497E+00 | 3.3644E+00 | 1.3532E+00 | 9.5301E−01 | 2.0347E−01 |
| A10 | 7.6214E−01 | −5.9296E+00 | −6.9248E+00 | −2.2421E+00 | −1.2946E+00 | −2.3844E−01 |
| A12 | −1.2937E+00 | 7.2574E+00 | 8.4463E+00 | 2.3296E+00 | 1.3128E+00 | 2.7463E−01 |
| A14 | 1.3539E+00 | −5.4786E+00 | −6.3665E+00 | −1.5429E+00 | −9.5973E−01 | −2.2952E−01 |
| A16 | −8.4740E−01 | 2.5097E+00 | 2.9138E+00 | 6.3011E−01 | 4.6523E−01 | 1.1827E−01 |
| A18 | 2.8749E−01 | −6.3885E−01 | −7.4106E−01 | −1.4385E−01 | −1.2982E−01 | −3.1767E−02 |
| A20 | −4.0142E−02 | 6.9060E−02 | 8.0107E−02 | 1.4028E−02 | 1.5472E−02 | 3.2432E−03 |
| Surface | | | | | | |
| number | S7 | S8 | S9 | S10 | S11 | S12 |
| K | −8.0516E+00 | −8.9590E+00 | 9.8939E+01 | 3.9938E+01 | −6.6241E+00 | −4.1319E+00 |
| A4 | 1.6614E−02 | −3.5984E−02 | 9.9761E−02 | −4.1114E−02 | −2.0808E−02 | 3.3886E−03 |
| A6 | 1.7534E−02 | 1.0372E−01 | −1.8518E−01 | 1.2895E−01 | −2.2003E−02 | −3.9529E−02 |
| A8 | −6.5853E−02 | −1.1566E−01 | 2.4265E−01 | −1.2719E−01 | 1.6325E−02 | 2.5584E−02 |
| A10 | 7.1068E−02 | 7.2149E−02 | −2.1852E−01 | 6.9164E−02 | −6.0807E−03 | −9.0041E−03 |
| A12 | −4.8437E−02 | −2.9849E−02 | 1.2513E−01 | −2.4150E−02 | 1.3773E−03 | 1.9359E−03 |
| A14 | 2.1979E−02 | 8.5308E−03 | −4.5439E−02 | 5.5067E−03 | −1.9275E−04 | −2.6027E−04 |
| A16 | −6.2245E−03 | −1.6200E−03 | 1.0161E−02 | −7.8534E−04 | 1.6295E−05 | 2.1299E−05 |
| A18 | 9.8193E−04 | 1.8126E−04 | −1.2741E−03 | 6.3174E−05 | −7.6474E−07 | −9.6945E−07 |
| A20 | −6.5642E−05 | −8.8711E−06 | 6.8354E−05 | −2.1822E−06 | 1.5349E−08 | 1.8861E−08 |

FIG. 1b illustrates a longitudinal spherical aberration curve, an astigmatism curve, and a distortion curve of the optical system of the embodiment of FIG. 1a. The longitudinal spherical aberration curve represents deviation in focal point of rays with different wavelengths after the rays go through the lenses of the optical system. The astigmatic curve represents tangential image plane bending and sagittal image plane bending. The distortion curve represents distortion values corresponding to different angles of view. As can be seen in FIG. 1b, the optical system in this embodiment has high imaging quality.

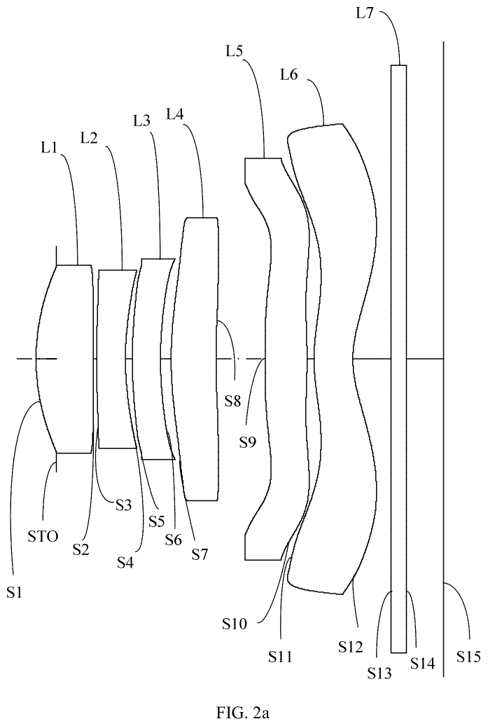

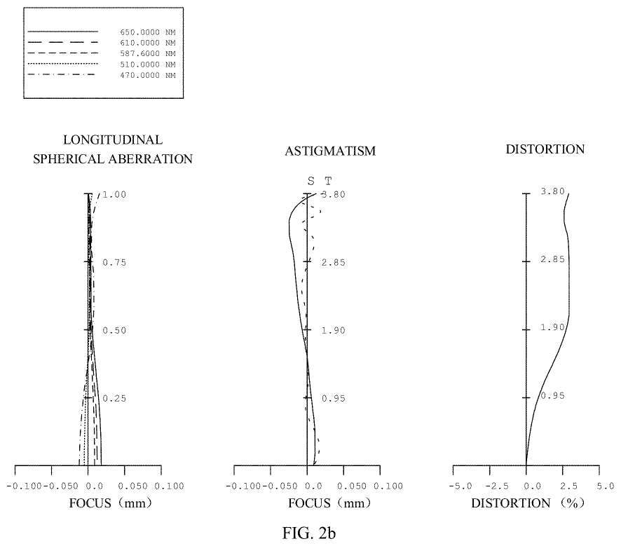

Referring to FIG. 2a and FIG. 2b, an optical system of this embodiment includes in order from an object side to an image side along an optical axis:

a first lens L1 with a positive refractive power, the first lens L1 having an object-side surface S1 which is convex both near the optical axis and near the periphery and an image-side surface S2 which is concave near the optical axis and convex near the periphery;

a second lens L2 with a negative refractive power, the second lens L2 having an object-side surface S3 which is convex near the optical axis and concave near the periphery and an image-side surface S4 which is concave both near the optical axis and near the periphery;

a third lens L3 with a negative refractive power, the third lens L3 having an object-side surface S5 which is convex both near the optical axis and near the periphery and an image-side surface S6 which is concave both near the optical axis and near the periphery;

a fourth lens L4 with a positive refractive power, the fourth lens L4 having an object-side surface S7 which is convex both near the optical axis and near the periphery and an image-side surface S8 which is concave near the optical axis and convex near the periphery;

a fifth lens L5 with a positive refractive power, the fifth lens L5 having an object-side surface S9 which is convex near the optical axis and concave near the periphery and an image-side surface S10 which is convex both near the optical axis and near the periphery; and

a sixth lens L6 with a negative refractive power, the sixth lens L6 having an object-side surface S11 which is convex near the optical axis and concave near the periphery and an image-side surface S12 which is concave near the optical axis and convex near the periphery.

Other structures of this embodiment are similar to that of the embodiment of FIG. 1a and reference may be made to the description above.

Table 2a shows characteristics of the optical system of this embodiment, where the data is obtained under a wavelength of 587.6 nm, and the Y radius, thickness, and focal length are measured in millimeters (mm).

TABLE 2a
Embodiment of FIG. 2a
f = 4.80 mm, FNO = 2.13, FOV = 72.31°, TTL = 5.79 mm

| Surface | Surface | Surface | | | | Refractive | Abbe | Focal |
|---|---|---|---|---|---|---|---|---|
| number | name | type | Y radius | thickness | material | index | number | length |
| Object surface | | spheric | infinity | infinity | | | | |
| STO | Stop | spheric | infinity | −0.286 | | | | |
| S1 | First | aspheric | 2.151 | 0.815 | plastic | 1.545 | 55.912 | 4.53 |
| S2 | lens | aspheric | 14.383 | 0.047 | | | | |
| S3 | Second | aspheric | 7.483 | 0.412 | plastic | 1.661 | 20.412 | −9.69 |
| S4 | lens | aspheric | 3.390 | 0.098 | | | | |
| S5 | Third | aspheric | 6.418 | 0.400 | plastic | 1.545 | 55.912 | −26.25 |
| S6 | lens | aspheric | 4.335 | 0.150 | | | | |
| S7 | Fourth | aspheric | 3.634 | 0.642 | plastic | 1.545 | 55.912 | 10.87 |
| S8 | lens | aspheric | 8.786 | 0.694 | | | | |
| S9 | Fifth | aspheric | 23.231 | 0.600 | plastic | 1.545 | 55.912 | 8.80 |
| S10 | lens | aspheric | −6.000 | 0.100 | | | | |
| S11 | Sixth | aspheric | 1.909 | 0.550 | plastic | 1.535 | 55.796 | −5.55 |
| S12 | lens | aspheric | 1.046 | 0.550 | | | | |
| S13 | Infrared | spheric | infinity | 0.210 | glass | 1.517 | 64.167 | |
| S14 | filter | spheric | infinity | 0.527 | | | | |
| S15 | Imaging | spheric | infinity | 0.000 | | | | |
| | surface | | | | | | | |

Definition of respective parameters in Table 2a is the same as that of respective parameters in the embodiment of FIG. 1a.

Table 2b shows high-order coefficients of respective aspheric surfaces in this embodiment, where the surface profiles of aspheric surfaces may be defined by the equation given in the embodiment of FIG. 1a.

TABLE 2b
Embodiment of FIG. 2a
Aspheric coefficients

| Surface | | | | | | |
|---|---|---|---|---|---|---|
| number | S1 | S2 | S3 | S4 | S5 | S6 |
| K | −1.4219E+00 | 4.4618E+01 | −8.5244E+01 | −2.0163E+01 | −1.0782E+01 | 1.0547E+01 |
| A4 | 8.5542E−03 | −6.0681E−02 | −1.9503E−02 | 1.3153E−01 | 1.2231E−01 | −7.6075E−03 |
| A6 | 2.1788E−02 | −2.1342E−01 | −3.1069E−01 | −3.0418E−01 | −2.0078E−01 | 1.6642E−02 |
| A8 | −1.1056E−01 | 1.0097E+00 | 1.2817E+00 | 1.2416E−01 | −4.1548E−01 | −2.3041E−01 |
| A10 | 3.0406E−01 | −2.2837E+00 | −2.8488E+00 | 9.9035E−01 | 2.2683E+00 | 6.5696E−01 |
| A12 | −5.3277E−01 | 3.5547E+00 | 4.4954E+00 | −2.7069E+00 | −4.7709E+00 | −1.1621E+00 |
| A14 | 5.9234E−01 | −3.9222E+00 | −5.0451E+00 | 3.5055E+00 | 5.8808E+00 | 1.3478E+00 |
| A16 | −4.0597E−01 | 2.8154E+00 | 3.6691E+00 | −2.5399E+00 | −4.2894E+00 | −9.5662E−01 |
| A18 | 1.5595E−01 | −1.1489E+00 | −1.5110E+00 | 9.9391E−01 | 1.7139E+00 | 3.7591E−01 |
| A20 | −2.5706E−02 | 1.9994E−01 | 2.6456E−01 | −1.6634E−01 | −2.9151E−01 | −6.3094E−02 |
| Surface | | | | | | |
| number | S7 | S8 | S9 | S10 | S11 | S12 |
| K | −1.9887E+01 | −9.9000E+01 | 8.4972E+01 | −9.9000E+01 | −1.1715E+01 | −4.6015E+00 |
| A4 | −3.1310E−03 | −1.6963E−02 | 1.2786E−01 | 1.0725E−01 | −8.9927E−02 | −8.4654E−02 |
| A6 | −1.6695E−02 | −7.8257E−03 | −1.9016E−01 | −8.8636E−02 | −4.3843E−04 | 3.7850E−02 |
| A8 | 7.3533E−02 | 2.4631E−02 | 2.0648E−01 | 6.8235E−02 | 2.9547E−02 | −1.5248E−02 |
| A10 | −1.5498E−01 | −2.1746E−02 | −1.7075E−01 | −4.5786E−02 | −2.2448E−02 | 4.8472E−03 |
| A12 | 1.7181E−01 | 9.3662E−03 | 9.3883E−02 | 2.0294E−02 | 8.8910E−03 | −1.2090E−03 |
| A14 | −1.1246E−01 | −2.0397E−03 | −3.3010E−02 | −5.6271E−03 | −2.0734E−03 | 2.1876E−04 |
| A16 | 4.4177E−02 | 2.7746E−04 | 7.0328E−03 | 9.3653E−04 | 2.8598E−04 | −2.5421E−05 |
| A18 | −9.5967E−03 | −5.8440E−05 | −8.1707E−04 | −8.5074E−05 | −2.1602E−05 | 1.6440E−06 |
| A20 | 8.8047E−04 | 8.6778E−06 | 3.9453E−05 | 3.2320E−06 | 6.8871E−07 | −4.4469E−08 |

FIG. 2b illustrates a longitudinal spherical aberration curve, an astigmatism curve, and a distortion curve of the optical system of the embodiment of FIG. 2a. As can be seen in FIG. 2b, the optical system in this embodiment has high imaging quality.

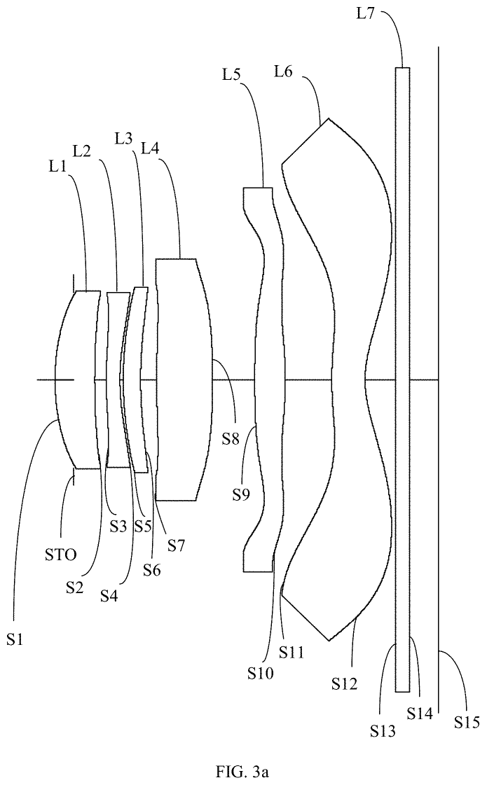

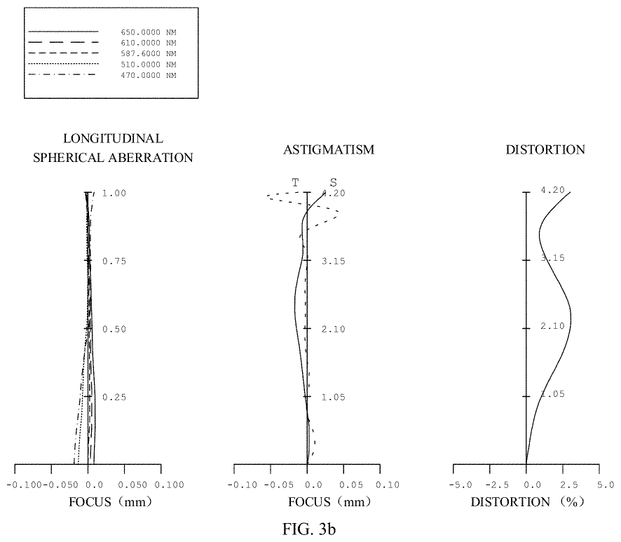

Referring to FIG. 3a and FIG. 3b, an optical system of this embodiment includes in order from an object side to an image side along an optical axis:

a first lens L1 with a positive refractive power, the first lens L1 having an object-side surface S1 which is convex both near the optical axis and near the periphery and an image-side surface S2 which is concave both near the optical axis and near the periphery;

a second lens L2 with a negative refractive power, the second lens L2 having an object-side surface S3 which is convex near the optical axis and concave near the periphery and an image-side surface S4 which is concave both near the optical axis and near the periphery;

a third lens L3 with a positive refractive power, the third lens L3 having an object-side surface S5 which is convex both near the optical axis and near the periphery and an image-side surface S6 which is concave both near the optical axis and near the periphery;

a fourth lens L4 with a positive refractive power, the fourth lens L4 having an object-side surface S7 which is convex near the optical axis and concave near the periphery and an image-side surface S8 which is convex both near the optical axis and near the periphery;

a fifth lens L5 with a positive refractive power, the fifth lens L5 having an object-side surface S9 which is convex near the optical axis and concave near the periphery and an image-side surface S10 which is convex near the optical axis and concave near the periphery;

a sixth lens L6 with a negative refractive power, the sixth lens L6 having an object-side surface S11 which is convex near the optical axis and concave near the periphery and an image-side surface S12 which is concave near the optical axis and convex near the periphery.

Other structures of this embodiment are similar to that of the embodiment of FIG. 1a and reference may be made to the description above.

Table 3a shows characteristics of the optical system of this embodiment, where the data is obtained under a wavelength of 587.6 nm, and the Y radius, thickness, and focal length are measured in millimeters (mm).

TABLE 3a
Embodiment of FIG. 3a
f = 4.44 mm, FNO = 2.0, FOV = 82.92°, TTL = 5.75 mm

| Surface | Surface | Surface | | | | Refractive | Abbe | Focal |
|---|---|---|---|---|---|---|---|---|
| number | name | type | Y radius | thickness | material | index | number | length |
| Object surface | | spheric | infinity | infinity | | | | |
| STO | Stop | spheric | infinity | −0.285 | | | | |
| S1 | First | aspheric | 2.301 | 0.596 | plastic | 1.545 | 55.912 | 5.96 |
| S2 | lens | aspheric | 7.184 | 0.172 | | | | |
| S3 | Second | aspheric | 3.861 | 0.206 | plastic | 1.661 | 20.412 | −9.88 |
| S4 | lens | aspheric | 2.375 | 0.052 | | | | |
| S5 | Third | aspheric | 4.157 | 0.260 | plastic | 1.545 | 55.912 | 66.81 |
| S6 | lens | aspheric | 4.591 | 0.240 | | | | |
| S7 | Fourth | aspheric | 9.822 | 0.837 | plastic | 1.545 | 55.912 | 9.06 |
| S8 | lens | aspheric | −9.597 | 0.635 | | | | |
| S9 | Fifth | aspheric | 20.498 | 0.456 | plastic | 1.545 | 55.912 | 6.10146 |
| S10 | lens | aspheric | −3.930 | 0.696 | | | | |
| S11 | Sixth | aspheric | 2.822 | 0.500 | plastic | 1.535 | 55.796 | −3.922875 |
| S12 | lens | aspheric | 1.129 | 0.459 | | | | |
| S13 | Infrared | spheric | infinity | 0.210 | glass | 1.517 | 64.167 | |
| S14 | filter | spheric | infinity | 0.430 | | | | |
| S15 | Imaging | spheric | infinity | 0.000 | | | | |
| | surface | | | | | | | |

Definition of respective parameters in Table 3a is the same as that of respective parameters in the embodiment of FIG. 1a.

Table 3b shows high-order coefficients of respective aspheric surfaces in this embodiment, where the surface profiles of aspheric surfaces may be defined by the equation given in the embodiment of FIG. 1a.

TABLE 3b
Embodiment of FIG. 3a
Aspheric coefficients

| Surface | | | | | | |
|---|---|---|---|---|---|---|
| number | S1 | S2 | S3 | S4 | S5 | S6 |
| K | −3.5445E−01 | 3.7430E+01 | −9.0206E+01 | −2.8852E+01 | −7.7964E+00 | 9.0824E+00 |
| A4 | 8.2807E−03 | −5.0628E−02 | 3.2135E−02 | 1.6386E−01 | 2.3743E−02 | −6.1238E−02 |
| A6 | 3.7693E−03 | 1.8743E−02 | −4.4219E−01 | −4.7663E−01 | 1.5871E−01 | 9.5324E−02 |
| A8 | 1.2644E−02 | 1.3019E−01 | 1.3363E+00 | 9.3089E−01 | −7.8378E−01 | −1.8510E−01 |
| A10 | −3.9151E−02 | −5.4016E−01 | −2.8120E+00 | −1.4876E+00 | 1.8960E+00 | 2.4408E−01 |
| A12 | 1.0496E−01 | 1.2195E+00 | 4.4646E+00 | 1.8505E+00 | −3.1904E+00 | −2.3578E−01 |
| A14 | −1.6668E−01 | −1.6337E+00 | −5.0608E+00 | −1.7734E+00 | 3.5341E+00 | 1.0325E−01 |
| A16 | 1.5513E−01 | 1.2508E+00 | 3.6916E+00 | 1.2594E+00 | −2.3120E+00 | 4.9762E−02 |
| A18 | −7.6353E−02 | −4.9350E−01 | −1.5168E+00 | −5.6536E−01 | 7.9279E−01 | −6.7977E−02 |
| A20 | 1.5434E−02 | 7.3977E−02 | 2.6246E−01 | 1.1308E−01 | −1.0821E−01 | 1.8416E−02 |
| Surface | | | | | | |
| number | S7 | S8 | S9 | S10 | S11 | S12 |
| K | −7.8941E+01 | −2.0047E+01 | 8.4972E+01 | −9.9000E+01 | −1.1715E+01 | −4.6015E+00 |
| A4 | −4.0442E−02 | −3.4892E−02 | 1.2786E−01 | 1.0725E−01 | −8.9927E−02 | −8.4654E−02 |
| A6 | 4.8141E−02 | −1.0025E−03 | −1.9016E−01 | −8.8636E−02 | −4.3843E−04 | 3.7850E−02 |
| A8 | −1.8675E−01 | −3.4491E−03 | 2.0648E−01 | 6.8235E−02 | 2.9547E−02 | −1.5248E−02 |
| A10 | 5.4413E−01 | −1.0461E−02 | −1.7075E−01 | −4.5786E−02 | −2.2448E−02 | 4.8472E−03 |
| A12 | −9.7904E−01 | 3.4919E−02 | 9.3883E−02 | 2.0294E−02 | 8.8910E−03 | −1.2090E−03 |
| A14 | 1.0806E+00 | −3.7347E−02 | −3.3010E−02 | −5.6271E−03 | −2.0734E−03 | 2.1876E−04 |
| A16 | −7.1978E−01 | 2.0081E−02 | 7.0328E−03 | 9.3653E−04 | 2.8598E−04 | −2.5421E−05 |
| A18 | 2.6675E−01 | −5.4684E−03 | −8.1707E−04 | −8.5074E−05 | −2.1602E−05 | 1.6440E−06 |
| A20 | −4.2559E−02 | 6.0253E−04 | 3.9453E−05 | 3.2320E−06 | 6.8871E−07 | −4.4469E−08 |

FIG. 3b shows a longitudinal spherical aberration curve, an astigmatism curve, and a distortion curve of the optical system of the embodiment of FIG. 3a. As can be seen from FIG. 3b, the optical system of this embodiment has high imaging quality.

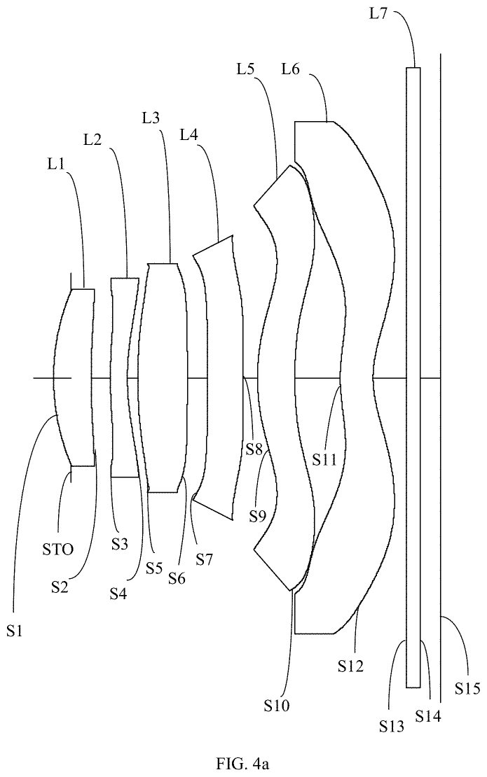

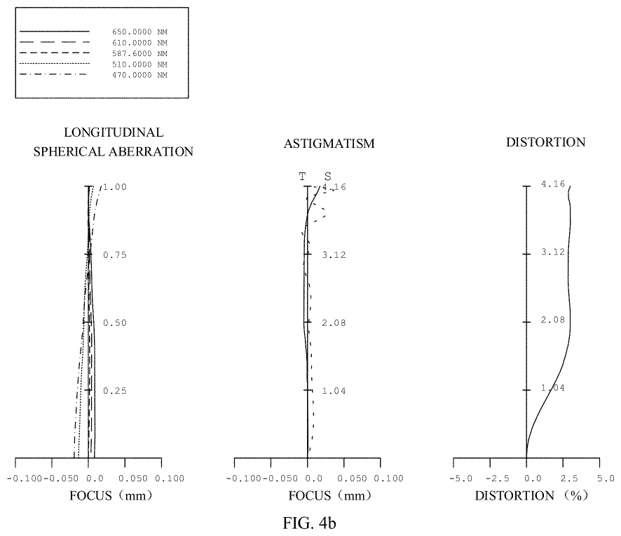

Referring to FIG. 4a and FIG. 4b, an optical system of this embodiment includes in order from an object side to an image side along an optical axis:

a first lens L1 with a positive refractive power, the first lens L1 having an object-side surface S1 which is convex both near the optical axis and near the periphery and an image-side surface S2 which is concave near the optical axis and convex near the periphery;

a second lens L2 with a negative refractive power, the second lens L2 having an object-side surface S3 which is convex near the optical axis and concave near the periphery and an image-side surface S4 which is concave both near the optical axis and near the periphery;

a third lens L3 with a positive refractive power, the third lens L3 having an object-side surface S5 which is convex both near the optical axis and near the periphery and an image-side surface S6 which is convex both near the optical axis and near the periphery;

a fourth lens L4 with a negative refractive power, the fourth lens L4 having an object-side surface S7 which is convex near the optical axis and concave near the periphery and an image-side surface S8 which is concave both near the optical axis and near the periphery;

a fifth lens L5 with a positive refractive power, the fifth lens L5 having an object-side surface S9 which is convex near the optical axis and concave near the periphery and an image-side surface S10 which is concave near the optical axis and convex near the periphery;

a sixth lens L6 with a negative refractive power, the sixth lens L6 having an object-side surface S11 which is convex near the optical axis and concave near the periphery and an image-side surface S12 which is concave near the optical axis and convex near the periphery.

Other structures of this embodiment are similar to that of the embodiment of FIG. 1a and reference may be made to the description above.

Table 4a shows characteristics of the optical system of this embodiment, where the data is obtained under a wavelength of 587.6 nm, and the Y radius, thickness, and focal length are measured in millimeters (mm).

TABLE 4a
Embodiment of FIG. 4a
f = 4.48 mm, FNO = 2.0, FOV = 81.96°, TTL = 5.9 mm

| Surface | Surface | Surface | | | | Refractive | Abbe | Focal |
|---|---|---|---|---|---|---|---|---|
| number | name | type | Y radius | thickness | material | index | number | length |
| Object surface | | spheric | infinity | infinity | | | | |
| STO | Stop | spheric | infinity | −0.262 | | | | |
| S1 | First | aspheric | 2.423 | 0.574 | plastic | 1.545 | 55.912 | 6.36 |
| S2 | lens | aspheric | 7.416 | 0.291 | | | | |
| S3 | Second | aspheric | 4.102 | 0.260 | plastic | 1.661 | 20.412 | −10.42 |
| S4 | lens | aspheric | 2.506 | 0.160 | | | | |
| S5 | Third | aspheric | 5.513 | 0.754 | plastic | 1.545 | 55.912 | 9.72 |
| S6 | lens | aspheric | −123.052 | 0.300 | | | | |
| S7 | Fourth | aspheric | 49.330 | 0.550 | plastic | 1.545 | 55.912 | −45.76 |
| S8 | lens | aspheric | 16.481 | 0.220 | | | | |
| S9 | Fifth | aspheric | 2.242 | 0.570 | plastic | 1.545 | 55.912 | 7.53 |
| S10 | lens | aspheric | 4.506 | 0.694 | | | | |
| S11 | Sixth | aspheric | 1.994 | 0.500 | plastic | 1.535 | 55.796 | −6.73 |
| S12 | lens | aspheric | 1.171 | 0.504 | | | | |
| S13 | Infrared | spheric | infinity | 0.210 | glass | 1.517 | 64.167 | |
| S14 | filter | spheric | infinity | 0.312 | | | | |
| S15 | Imaging | spheric | infinity | 0.000 | | | | |
| | surface | | | | | | | |

Definition of respective parameters in Table 4a is the same as that of respective parameters in the embodiment of FIG. 1a.

Table 4b shows high-order coefficients of respective aspheric surfaces in this embodiment, where the surface profiles of aspheric surfaces may be defined by the equation given in the embodiment of FIG. 1a.

TABLE 4b
Embodiment of FIG. 4a
Aspheric coefficients

| Surface | | | | | | |
|---|---|---|---|---|---|---|
| number | S1 | S2 | S3 | S4 | S5 | S6 |
| K | −8.7057E−01 | 2.0780E+01 | −9.9000E+01 | −2.7472E+01 | −1.1446E+01 | 9.9000E+01 |
| A4 | 5.8346E−03 | −3.6000E−02 | 5.8484E−02 | 1.2430E−01 | 2.2316E−02 | 1.4053E−03 |
| A6 | 9.1643E−04 | 3.3170E−02 | −3.7072E−01 | −3.4873E−01 | −2.6691E−03 | −5.9635E−02 |
| A8 | −7.7246E−03 | −1.3966E−01 | 8.3271E−01 | 6.2725E−01 | −6.8973E−02 | 1.4531E−01 |
| A10 | 4.7493E−02 | 4.2791E−01 | −1.2642E+00 | −8.0833E−01 | 2.0523E−01 | −2.6022E−01 |
| A12 | −1.2758E−01 | −8.2617E−01 | 1.2394E+00 | 7.2046E−01 | −3.4142E−01 | 2.9866E−01 |
| A14 | 1.8610E−01 | 9.8636E−01 | −6.8517E−01 | −4.1776E−01 | 3.4260E−01 | −2.2244E−01 |
| A16 | −1.5436E−01 | −7.1384E−01 | 1.2119E−01 | 1.3862E−01 | −2.0604E−01 | 1.0314E−01 |
| A18 | 6.8355E−02 | 2.8714E−01 | 5.9049E−02 | −1.9143E−02 | 6.7875E−02 | −2.7143E−02 |
| A20 | −1.2596E−02 | −4.9453E−02 | −2.4253E−02 | −2.9646E−04 | −9.3067E−03 | 3.1197E−03 |
| Surface | | | | | | |
| number | S7 | S8 | S9 | S10 | S11 | S12 |
| K | 9.9000E+01 | 2.6427E+01 | −8.8336E+00 | −2.3376E+01 | −8.4482E+00 | −3.4147E+00 |
| A4 | −7.0023E−04 | −3.8129E−02 | 9.3845E−02 | 6.3459E−02 | −1.3247E−01 | −1.0473E−01 |
| A6 | −7.3772E−02 | −8.6313E−02 | −1.1637E−01 | −7.6524E−04 | −5.2374E−05 | 3.7152E−02 |
| A8 | 1.2993E−01 | 1.3234E−01 | 8.8125E−02 | −3.1992E−02 | 3.2051E−02 | −8.5498E−03 |
| A10 | −1.4868E−01 | −1.0711E−01 | −5.5449E−02 | 1.9848E−02 | −1.7513E−02 | 1.0677E−03 |
| A12 | 1.1288E−01 | 5.7665E−02 | 2.3604E−02 | −6.1989E−03 | 4.8555E−03 | −3.8939E−05 |
| A14 | −5.9073E−02 | −2.0565E−02 | −6.2700E−03 | 1.1550E−03 | −7.7337E−04 | −7.5585E−06 |
| A16 | 2.0864E−02 | 4.6850E−03 | 9.8843E−04 | −1.2986E−04 | 7.0103E−05 | 1.1813E−06 |
| A18 | −4.6274E−03 | −6.2354E−04 | −8.4140E−05 | 8.1582E−06 | −3.2768E−06 | −6.8434E−08 |
| A20 | 4.8954E−04 | 3.7139E−05 | 2.9724E−06 | −2.2106E−07 | 5.7894E−08 | 1.4843E−09 |

FIG. 4b shows a longitudinal spherical aberration curve, an astigmatism curve, and a distortion curve of the optical system of the embodiment of FIG. 4a. As can be seen from FIG. 4b, the optical system of this embodiment has high imaging quality.

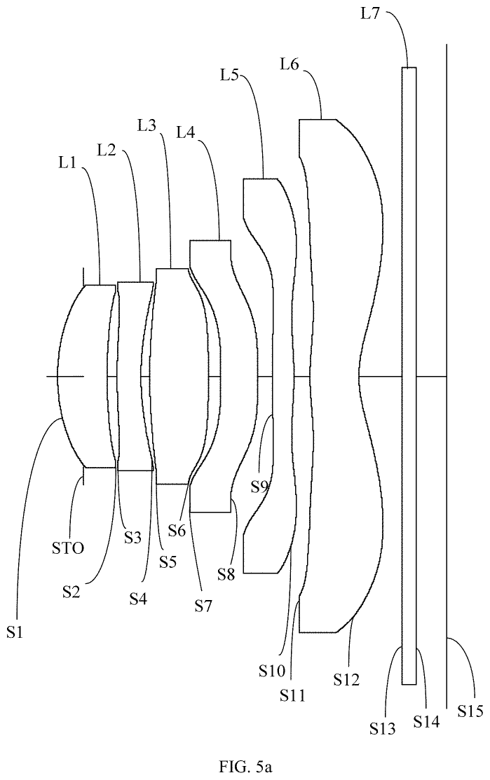

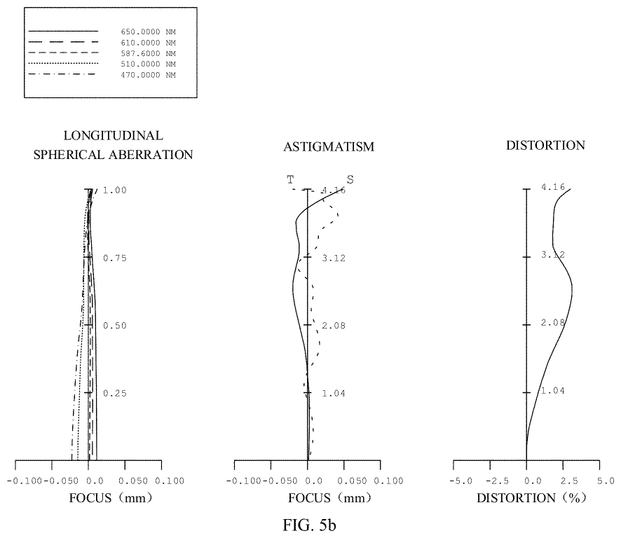

Referring to FIG. 5a and FIG. 5b, an optical system of this embodiment includes in order from an object side to an image side along an optical axis:

a first lens L1 with a positive refractive power, the first lens L1 having an object-side surface S1 which is convex both near the optical axis and near the periphery and an image-side surface S2 which is concave both near the optical axis and near the periphery;

a second lens L2 with a negative refractive power, the second lens L2 having an object-side surface S3 which is convex near the optical axis and concave near the periphery and an image-side surface S4 which is concave near the optical axis and convex near the periphery;

a third lens L3 with a positive refractive power, the third lens L3 having an object-side surface S5 which is convex both near the optical axis and near the periphery and an image-side surface S6 which is convex near the optical axis and concave near the periphery;

a fourth lens L4 with a negative refractive power, the fourth lens L4 having an object-side surface S7 which is concave both near the optical axis and near the periphery and an image-side surface S8 which is convex near the optical axis and concave near the periphery;

a fifth lens L5 with a positive refractive power, the fifth lens L5 having an object-side surface S9 which is convex near the optical axis and concave near the periphery and an image-side surface S10 which is convex both near the optical axis and near the periphery;

a sixth lens L6 with a negative refractive power, the sixth lens L6 having an object-side surface S11 which is convex near the optical axis and concave near the periphery and an image-side surface S12 which is concave near the optical axis and convex near the periphery.

Other structures of the embodiment of FIG. 5a are similar to that of the embodiment of FIG. 1a and reference may be made to the description above.

Table 5a shows characteristics of the optical system of this embodiment, where the data is obtained under a wavelength of 587.6 nm, and the Y radius, thickness, and focal length are measure in millimeters (mm).

TABLE 5a
Embodiment of FIG. 5a
f = 4.56 mm, FNO = 2.0, FOV = 81.38°, TTL = 5.81 mm

| Surface | Surface | Surface | | | | Refractive | Abbe | Focal |
|---|---|---|---|---|---|---|---|---|
| number | name | type | Y radius | thickness | material | index | number | length |
| Object surface | | spheric | infinity | infinity | | | | |
| STO | Stop | spheric | infinity | −0.386 | | | | |
| S1 | First | aspheric | 1.953 | 0.739 | plastic | 1.545 | 55.912 | 5.53 |
| S2 | lens | aspheric | 4.834 | 0.148 | | | | |
| S3 | Second | aspheric | 4.464 | 0.358 | plastic | 1.661 | 20.412 | −9.95 |
| S4 | lens | aspheric | 2.573 | 0.131 | | | | |
| S5 | Third | aspheric | 5.949 | 0.876 | plastic | 1.545 | 55.912 | 9.50 |
| S6 | lens | aspheric | −37.271 | 0.186 | | | | |
| S7 | Fourth | aspheric | −10.581 | 0.550 | plastic | 1.545 | 55.912 | −31.43 |
| S8 | lens | aspheric | −28.259 | 0.220 | | | | |
| S9 | Fifth | aspheric | 19.806 | 0.323 | plastic | 1.545 | 55.912 | 5.78 |
| S10 | lens | aspheric | −3.719 | 0.240 | | | | |
| S11 | Sixth | aspheric | 2.474 | 0.730 | plastic | 1.535 | 55.796 | −4.95 |
| S12 | lens | aspheric | 1.147 | 0.646 | | | | |
| S13 | Infrared | spheric | infinity | 0.210 | glass | 1.517 | 64.167 | |
| S14 | filter | spheric | infinity | 0.454 | | | | |
| S15 | Imaging | spheric | infinity | 0.000 | | | | |
| | surface | | | | | | | |

Definition of respective parameters in Table 5a is the same as that of respective parameters in the embodiment of FIG. 1a.

Table 5b shows high-order coefficients of respective aspheric surfaces in this embodiment, where the surface profiles of aspheric surfaces may be defined by the equation given in the embodiment of FIG. 1a.

TABLE 5b
Embodiment of FIG. 5a
Aspheric coefficients

| Surface | | | | | | |
|---|---|---|---|---|---|---|
| number | S1 | S2 | S3 | S4 | S5 | S6 |
| K | 2.2129E−02 | 1.6888E+01 | −6.5688E+01 | −1.9247E+01 | −2.9480E+01 | −9.9000E+01 |
| A4 | 6.5492E−03 | −6.2743E−02 | −4.0354E−02 | 4.3075E−02 | −7.4421E−03 | −1.4522E−01 |
| A6 | −9.1348E−04 | 5.6744E−02 | −1.8414E−02 | −1.1258E−01 | 3.8688E−03 | 2.3750E−01 |
| A8 | 3.4015E−02 | −3.6519E−02 | 9.4994E−03 | 2.9744E−01 | 7.4949E−02 | −4.1066E−01 |
| A10 | −7.9463E−02 | −9.4473E−03 | 2.2044E−01 | −5.3643E−01 | −3.8573E−01 | 3.1069E−01 |
| A12 | 1.3798E−01 | 1.0944E−01 | −6.0126E−01 | 7.0159E−01 | 9.1920E−01 | 7.4764E−03 |
| A14 | −1.6070E−01 | −2.5769E−01 | 6.3878E−01 | −6.7442E−01 | −1.2284E+00 | −2.3942E−01 |
| A16 | 1.2333E−01 | 3.0898E−01 | −2.5621E−01 | 4.4146E−01 | 9.2551E−01 | 1.9806E−01 |
| A18 | −5.4843E−02 | −1.8289E−01 | −2.6422E−02 | −1.6818E−01 | −3.5960E−01 | −6.4712E−02 |
| A20 | 1.0753E−02 | 3.9983E−02 | 3.0338E−02 | 2.6681E−02 | 5.5023E−02 | 7.4727E−03 |
| Surface | | | | | | |
| number | S7 | S8 | S9 | S10 | S11 | S12 |
| K | 5.6976E+01 | 6.7164E+01 | −3.1092E+00 | −3.9897E+01 | −3.9866E+00 | −4.9212E+00 |
| A4 | −2.5877E−01 | −2.4999E−01 | 8.6779E−02 | 4.0623E−02 | −2.8742E−01 | −8.8180E−02 |
| A6 | 2.2862E−01 | −3.8707E−02 | −2.6918E−01 | 1.2837E−01 | 2.3902E−01 | 4.4817E−02 |
| A8 | −8.7411E−02 | 3.4877E−01 | 3.8035E−01 | −1.7704E−01 | −1.2497E−01 | −1.4878E−02 |
| A10 | −4.8205E−01 | −4.9512E−01 | −3.5034E−01 | 1.0735E−01 | 4.4884E−02 | 2.9330E−03 |
| A12 | 1.1419E+00 | 4.1327E−01 | 2.0728E−01 | −3.8311E−02 | −1.1039E−02 | −2.9488E−04 |
| A14 | −1.2413E+00 | −2.0581E−01 | −7.8044E−02 | 8.5056E−03 | 1.8030E−03 | 2.5628E−06 |
| A16 | 7.5039E−01 | 5.9523E−02 | 1.7896E−02 | −1.1549E−03 | −1.8535E−04 | 2.5063E−06 |
| A18 | −2.3918E−01 | −9.2420E−03 | −2.2560E−03 | 8.7842E−05 | 1.0798E−05 | −2.2829E−07 |
| A20 | 3.1181E−02 | 5.9683E−04 | 1.1916E−04 | −2.8685E−06 | −2.7104E−07 | 6.4825E−09 |

FIG. 5b shows a longitudinal spherical aberration curve, an astigmatism curve, and a distortion curve of the optical system of the embodiment of FIG. 5a. As can be seen from FIG. 5b, the optical system of this embodiment has high imaging quality.

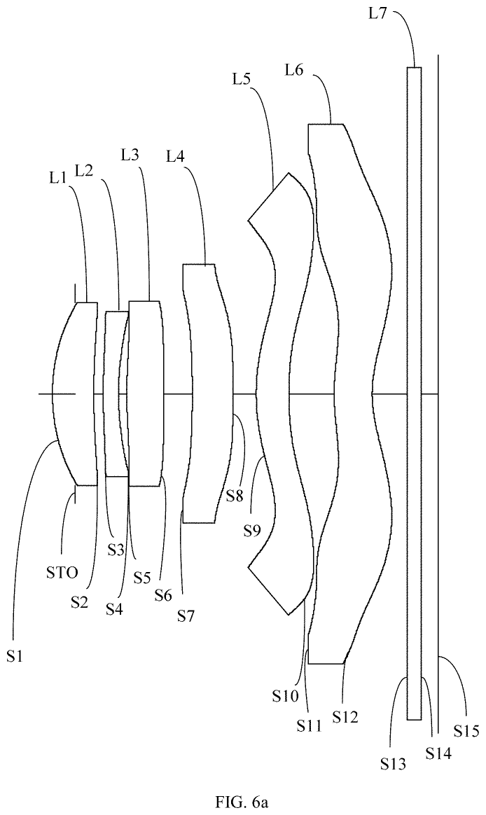

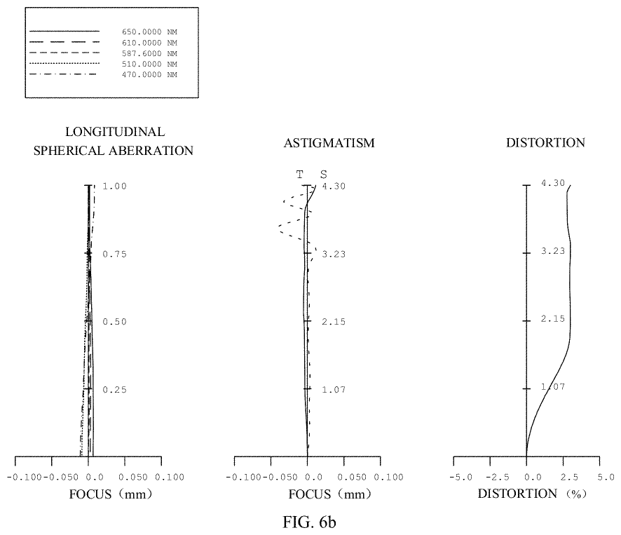

Referring to FIG. 6a and FIG. 6b, an optical system of this embodiment includes in order from an object side to an image side along an optical axis:

a first lens L1 with a positive refractive power, the first lens L1 having an object-side surface S1 which is convex both near the optical axis and near the periphery and an image-side surface S2 which is concave near the optical axis and convex near the periphery;

a second lens L2 with a negative refractive power, the second lens L2 having an object-side surface S3 which is convex both near the optical axis and near the periphery and an image-side surface S4 which is concave both near the optical axis and near the periphery;

a third lens L3 with a positive refractive power, the third lens L3 having an object-side surface S5 which is convex near the optical axis and concave near the periphery and an image-side surface S6 which is concave near the optical axis and convex near the periphery;

a fourth lens L4 with a positive refractive power, the fourth lens L4 having an object-side surface S7 which is concave both near the optical axis and near the periphery and an image-side surface S8 which is convex both near the optical axis and near the periphery;

a fifth lens L5 with a positive refractive power, the fifth lens L5 having an object-side surface S9 which is convex near the optical axis and concave near the periphery and an image-side surface S10 which is concave near the optical axis and convex near the periphery;

a sixth lens L6 with a negative refractive power, the sixth lens L6 having an object-side surface S11 which is convex near the optical axis and concave near the periphery and an image-side surface S12 which is concave near the optical axis and convex near the periphery.

Other structures of this embodiment are similar to that of the embodiment of FIG. 1a and reference may be made to the description above.

Table 6a shows characteristics of the optical system of this embodiment, where the data is obtained under a wavelength of 587.6 nm, and the Y radius, thickness, and focal length are measured in millimeters (mm).

TABLE 6a
Embodiment of FIG. 6a
f = 4.64 mm, FNO = 2.0, FOV = 82.79°, TTL = 5.8 mm

| Surface | Surface | Surface | | | | Refractive | Abbe | Focal |
|---|---|---|---|---|---|---|---|---|
| number | name | type | Y radius | thickness | material | index | number | length |
| Object surface | | spheric | infinity | infinity | | | | |
| STO | Stop | spheric | infinity | −0.341 | | | | |
| S1 | First | aspheric | 2.000 | 0.620 | plastic | 1.545 | 55.912 | 5.07 |
| S2 | lens | aspheric | 6.472 | 0.144 | | | | |
| S3 | Second | aspheric | 6.157 | 0.230 | plastic | 1.661 | 20.412 | −8.56 |
| S4 | lens | aspheric | 2.904 | 0.126 | | | | |
| S5 | Third | aspheric | 6.150 | 0.550 | plastic | 1.545 | 55.912 | 12.29 |
| S6 | lens | aspheric | 74.311 | 0.431 | | | | |
| S7 | Fourth | aspheric | −20.123 | 0.618 | plastic | 1.545 | 55.912 | 333.56 |
| S8 | lens | aspheric | −18.310 | 0.347 | | | | |
| S9 | Fifth | aspheric | 2.397 | 0.489 | plastic | 1.545 | 55.912 | 11.12 |
| S10 | lens | aspheric | 3.683 | 0.683 | | | | |
| S11 | Sixth | aspheric | 2.458 | 0.571 | plastic | 1.535 | 55.796 | −6.98 |
| S12 | lens | aspheric | 1.362 | 0.530 | | | | |
| S13 | Infrared | spheric | infinity | 0.210 | glass | 1.517 | 64.167 | |
| S14 | filter | spheric | infinity | 0.251 | | | | |
| S15 | Imaging | spheric | infinity | 0.000 | | | | |
| | surface | | | | | | | |

Definition of respective parameters in Table 6a is the same as that of respective parameters in the embodiment of FIG. 1a.

Table 6b shows high-order coefficients of respective aspheric surfaces in this embodiment, where the surface profiles of aspheric surfaces may be defined by the equation given in the embodiment of FIG. 1a.

TABLE 6b
Embodiment of FIG. 6a
Aspheric coefficients

| Surface | | | | | | |
|---|---|---|---|---|---|---|
| number | S1 | S2 | S3 | S4 | S5 | S6 |
| K | −3.0968E−01 | 7.1551E−01 | −8.2736E+01 | −2.1781E+01 | −9.9000E+01 | −9.8776E+01 |
| A4 | 6.3574E−03 | −3.7976E−02 | −5.2346E−02 | 3.7816E−02 | 2.0088E−02 | −2.1974E−02 |
| A6 | 6.5066E−03 | 3.2594E−02 | 4.5042E−02 | −5.9444E−02 | −8.5394E−02 | −4.1140E−02 |
| A8 | −2.6786E−02 | −9.4570E−02 | −6.5648E−02 | 1.7630E−01 | 1.6890E−01 | 1.6229E−01 |
| A10 | 8.6702E−02 | 2.8531E−01 | 2.5734E−01 | −3.5107E−01 | −4.7157E−01 | −4.5955E−01 |
| A12 | −1.6343E−01 | −5.8658E−01 | −6.4930E−01 | 5.1192E−01 | 1.0200E+00 | 7.8233E−01 |
| A14 | 1.8350E−01 | 7.3872E−01 | 9.4675E−01 | −5.4878E−01 | −1.5494E+00 | −8.2944E−01 |
| A16 | −1.2207E−01 | −5.5181E−01 | −7.9345E−01 | 4.2578E−01 | 1.4852E+00 | 5.3580E−01 |
| A18 | 4.4315E−02 | 2.2356E−01 | 3.5577E−01 | −2.0774E−01 | −7.8956E−01 | −1.9208E−01 |
| A20 | −6.8657E−03 | −3.7870E−02 | −6.6135E−02 | 4.5883E−02 | 1.7567E−01 | 2.9144E−02 |
| Surface | | | | | | |
| number | S7 | S8 | S9 | S10 | S11 | S12 |
| K | 9.9000E+01 | 5.7220E+01 | −1.0546E+01 | −4.0547E+01 | −1.0191E+01 | −3.7649E+00 |
| A4 | −3.3414E−02 | −5.6744E−02 | 9.1097E−02 | 1.1617E−01 | −1.3865E−01 | −9.9966E−02 |
| A6 | −3.1269E−02 | −4.0493E−02 | −9.8409E−02 | −7.4953E−02 | 4.9450E−02 | 4.6330E−02 |
| A8 | 6.6674E−02 | 7.5896E−02 | 5.9544E−02 | 2.3129E−02 | −2.0307E−02 | −1.7575E−02 |
| A10 | −6.2608E−02 | −6.6555E−02 | −3.0640E−02 | −4.1119E−03 | 8.5059E−03 | 4.6029E−03 |
| A12 | 1.6139E−02 | 4.1178E−02 | 1.1583E−02 | 2.9944E−04 | −2.1772E−03 | −8.0333E−04 |
| A14 | 2.1769E−02 | −1.8845E−02 | −2.9791E−03 | 4.3606E−05 | 3.2058E−04 | 9.1076E−05 |
| A16 | −2.0548E−02 | 6.4042E−03 | 4.8005E−04 | −1.3162E−05 | −2.7110E−05 | −6.3734E−06 |
| A18 | 7.0478E−03 | −1.3568E−03 | −4.2386E−05 | 1.2374E−06 | 1.2329E−06 | 2.4837E−07 |
| A20 | −9.3503E−04 | 1.2405E−04 | 1.5277E−06 | −4.1614E−08 | −2.3476E−08 | −4.1092E−09 |

FIG. 6b shows a longitudinal spherical aberration curve, an astigmatism curve, and a distortion curve of the optical system of the embodiment of FIG. 6a. As can be seen from FIG. 6b, the optical system of this embodiment has high imaging quality.

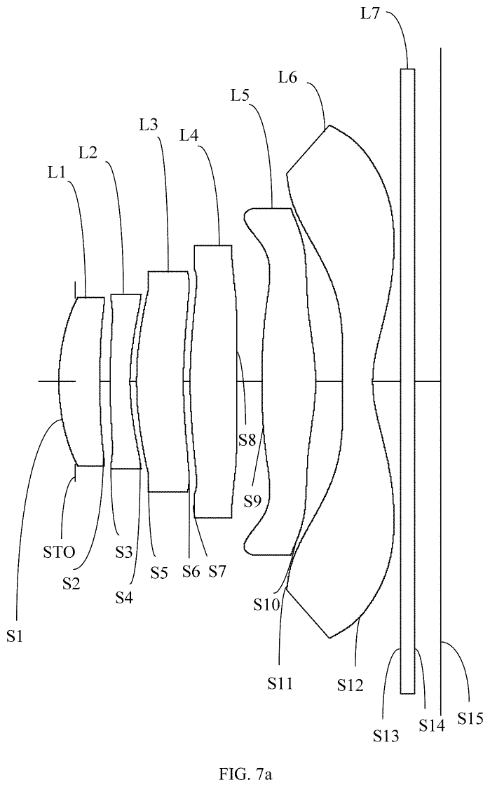

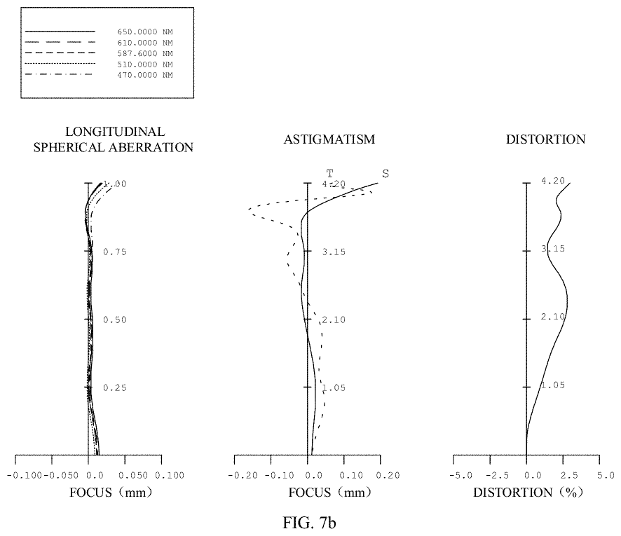

Referring to FIG. 7a and FIG. 7b, an optical system of this embodiment includes in order from an object side to an image side along an optical axis:

a first lens L1 with a positive refractive power, the first lens L1 having an object-side surface S1 which is convex both near the optical axis and near the periphery and an image-side surface S2 which is concave both near the optical axis and near the periphery;

a second lens L2 with a negative refractive power, the second lens L2 having an object-side surface S3 which is convex near the optical axis and concave near the periphery and an image-side surface S4 which is concave both near the optical axis and near the periphery;

a third lens L3 with a positive refractive power, the third lens L3 having an object-side surface S5 which is convex both near the optical axis and near the periphery and an image-side surface S6 which is concave near the optical axis and convex near the periphery;

a fourth lens L4 with a positive refractive power, the fourth lens L4 having an object-side surface S7 which is convex near the optical axis and concave near the periphery and an image-side surface S8 which is concave both near the optical axis and near the periphery;

a fifth lens L5 with a positive refractive power, the fifth lens L5 having an object-side surface S9 which is convex near the optical axis and concave near the periphery and an image-side surface S10 which is convex both near the optical axis and near the periphery;

a sixth lens L6 with a negative refractive power, the sixth lens L6 having an object-side surface S11 which is convex near the optical axis and concave near the periphery and an image-side surface S12 which is concave near the optical axis and convex near the periphery.

Other structures of this embodiment are similar to that of the embodiment of FIG. 1a and reference may be made to the description above.

Table 7a shows characteristics of the optical system of this embodiment, where the data is obtained under a wavelength of 587.6 nm, and the Y radius, thickness, and focal length are measured in millimeters (mm).

TABLE 7a
Embodiment of FIG. 7a
f = 4.19 mm, FNO = 2.0, FOV = 86.26°, TTL = 5.70 mm

| Surface | Surface | Surface | | | | Refractive | Abbe | Focal |
|---|---|---|---|---|---|---|---|---|
| number | name | type | Y radius | thickness | material | index | number | length |
| Object surface | | spheric | infinity | infinity | | | | |
| STO | Stop | spheric | infinity | −0.244 | | | | |
| S1 | First | aspheric | 2.280 | 0.609 | plastic | 1.545 | 55.912 | 5.86 |
| S2 | lens | aspheric | 7.257 | 0.155 | | | | |
| S3 | Second | aspheric | 5.011 | 0.296 | plastic | 1.661 | 20.412 | −6.59 |
| S4 | lens | aspheric | 2.274 | 0.100 | | | | |
| S5 | Third | aspheric | 3.161 | 0.700 | plastic | 1.545 | 55.912 | 13.14 |
| S6 | lens | aspheric | 5.223 | 0.100 | | | | |
| S7 | Fourth | aspheric | 4.839 | 0.700 | plastic | 1.545 | 55.912 | 9.24 |
| S8 | lens | aspheric | 120.863 | 0.376 | | | | |
| S9 | Fifth | aspheric | 18.570 | 0.800 | plastic | 1.545 | 55.912 | 3.38 |
| S10 | lens | aspheric | −2.013 | 0.399 | | | | |
| S11 | Sixth | aspheric | 16.260 | 0.450 | plastic | 1.535 | 55.796 | −2.41 |
| S12 | lens | aspheric | 1.185 | 0.420 | | | | |
| S13 | Infrared | spheric | infinity | 0.210 | glass | 1.517 | 64.167 | |
| S14 | filter | spheric | infinity | 0.391 | | | | |
| S15 | Imaging | spheric | infinity | 0.000 | | | | |
| | surface | | | | | | | |

Definition of respective parameters in Table 7a is the same as that of respective parameters in the embodiment of FIG. 1a.

Table 7b shows high-order coefficients of respective aspheric surfaces in this embodiment, where the surface profiles of aspheric surfaces may be defined by the equation given in the embodiment of FIG. 1a.

TABLE 7b
Embodiment of FIG. 7a
Aspheric coefficients

| Surface | | | | | | |
|---|---|---|---|---|---|---|
| number | S1 | S2 | S3 | S4 | S5 | S6 |
| K | −3.3149E−01 | 3.5709E+01 | −7.7089E+01 | −2.5668E+01 | −1.2060E+01 | 9.5514E+00 |
| A4 | 4.0731E−03 | −6.2889E−02 | −4.0346E−02 | 1.3970E−01 | −4.7260E−03 | −7.9661E−02 |
| A6 | 1.1703E−01 | 3.4359E−01 | −1.6168E−01 | −6.9021E−01 | −3.1248E−02 | 1.4643E−01 |
| A8 | −6.9998E−01 | −1.3786E+00 | 1.4843E+00 | 2.5979E+00 | 2.3044E−01 | −2.8557E−01 |
| A10 | 2.3806E+00 | 3.5832E+00 | −5.5903E+00 | −6.3034E+00 | −5.0694E−01 | 4.1270E−01 |
| A12 | −4.8087E+00 | −5.9925E+00 | 1.1963E+01 | 9.7875E+00 | 6.1719E−01 | −4.2643E−01 |
| A14 | 5.9729E+00 | 6.2790E+00 | −1.5666E+01 | −9.7213E+00 | −4.5831E−01 | 2.9196E−01 |
| A16 | −4.4889E+00 | −3.9466E+00 | 1.2388E+01 | 5.9628E+00 | 2.0407E−01 | −1.2416E−01 |
| A18 | 1.8777E+00 | 1.3367E+00 | −5.4342E+00 | −2.0550E+00 | −5.0068E−02 | 2.9083E−02 |
| A20 | −3.3626E−01 | −1.8386E−01 | 1.0139E+00 | 3.0407E−01 | 5.2454E−03 | −2.8088E−03 |
| Surface | | | | | | |
| number | S7 | S8 | S9 | S10 | S11 | S12 |
| K | −2.8834E+01 | 9.9000E+01 | 7.1553E+01 | −1.1731E+01 | −3.7583E−01 | −5.7712E+00 |
| A4 | −4.5408E−02 | 8.7724E−03 | 9.9354E−02 | 5.3763E−02 | −1.3543E−01 | −6.1965E−02 |
| A6 | 9.6546E−02 | −6.6393E−02 | −9.3920E−02 | 3.9945E−03 | 4.3843E−02 | 1.5576E−02 |
| A8 | −1.7230E−01 | 6.0299E−02 | 7.0574E−02 | −1.2318E−02 | −6.6045E−03 | 6.6847E−04 |
| A10 | 2.6317E−01 | −2.6776E−02 | −5.5887E−02 | 3.4187E−03 | −2.8986E−03 | −1.9604E−03 |
| A12 | −2.8506E−01 | 1.3573E−03 | 3.3894E−02 | −1.3515E−04 | 2.3839E−03 | 6.7714E−04 |
| A14 | 1.9685E−01 | 5.8260E−03 | −1.3827E−02 | −1.6775E−04 | −7.2492E−04 | −1.2107E−04 |
| A16 | −8.1877E−02 | −3.1904E−03 | 3.3871E−03 | 5.0535E−05 | 1.1478E−04 | 1.2289E−05 |
| A18 | 1.8442E−02 | 7.0528E−04 | −4.4116E−04 | −6.0584E−06 | −9.3636E−06 | −6.6668E−07 |
| A20 | −1.7278E−03 | −5.8184E−05 | 2.3430E−05 | 2.6736E−07 | 3.1097E−07 | 1.4966E−08 |

FIG. 7b shows a longitudinal spherical aberration curve, an astigmatism curve, and a distortion curve of the optical system of the embodiment of FIG. 7a. As can be seen from FIG. 7b, the optical system of this embodiment has high imaging quality.

Table 8 shows values of |SAG41|/|SAG42|, (CT2+CT3+CT4)/(CT23+CT34), f/|f3|+f/|f4|, |SAG61/CT6|, ∥R51|−|R52∥/∥R51|+|R52∥, f123/|f56|, (CT1+BF)/FNO, |f3|/n3, and ET34/ImgH of the optical systems in the above embodiments.

TABLE 8

| | | (CT2 + CT3 + CT4)/ | | | |
|---|---|---|---|---|---|
| | \|SAG4\|/\|SAG42\| | (CT23 + CT34) | f/\|f3\| + f/\|f4\| | \|SAG61/CT6\| | \|f3\|/n3 |
| Embodiment | 1.14 | 3.75 | 0.62 | 0.11 | 22.65 |
| of FIG. 1a | | | | | |
| Embodiment | 19.75 | 5.80 | 0.62 | 0.67 | 17.05 |
| of FIG. 2a | | | | | |
| Embodiment | 0.06 | 4.52 | 0.56 | 1.50 | 14.70 |
| of FIG. 3a | | | | | |
| Embodiment | 1.31 | 2.21 | 0.56 | 1.4 | 6.29 |
| of FIG. 4a | | | | | |
| Embodiment | 1.16 | 5.59 | 0.63 | 0.22 | 6.15 |
| of FIG. 5a | | | | | |
| Embodiment | 0.52 | 2.50 | 0.39 | 0.68 | 7.95 |
| of FIG. 6a | | | | | |
| Embodiment | 0.76 | 8.50 | 0.77 | 1.80 | 8.50 |
| of FIG. 7a | | | | | |

| | f123/\|f56\| | \|\|R51\| − \|R52\|\|/\|\|R51\| + \|R52\|\| | (CT1 + BF)/FNO | ET34/ImgH |
|---|---|---|---|---|
| Embodiment | 0.12 | 0.31 | 0.78 | 0.12 |
| of FIG. 1a | | | | |
| Embodiment | 0.36 | 0.59 | 0.83 | 0.03 |
| of FIG. 2a | | | | |
| Embodiment | 0.35 | 0.68 | 0.65 | 0.03 |
| of FIG. 3a | | | | |
| Embodiment | 0.19 | 0.34 | 0.64 | 0.06 |
| of FIG. 4a | | | | |
| Embodiment | 0.10 | 0.68 | 0.85 | 0.01 |
| of FIG. 5a | | | | |
| Embodiment | 0.06 | 0.21 | 0.66 | 0.08 |
| of FIG. 6a | | | | |
| Embodiment | 0.22 | 0.80 | 0.66 | 0.02 |
| of FIG. 7a | | | | |

As can be seen from Table 8, the respective embodiments satisfy the following expressions: |SAG41|/|SAG42|<20.0, 2.2<(CT2+CT3+CT4)/(CT23+CT34) [symbol] 8.5, 0.35<f/|f3|+f/|f4|<0.8, |SAG61/CT6| [symbol] 1.8, 0.2<∥R51|−|R52∥/∥R51|+|R52∥ [symbol] 0.8, f123/|f56| [symbol] 0.36, 0.60<(CT1+BF)/FNO 0.85, 6.1<|f3|/n3<22.7, ET34/ImgH [symbol] 0.12.

The technical features of the above embodiments can be combined arbitrarily. In order to make the description brief, all possible combinations of the technical features in the above embodiments are not described. However, as long as there is no contradiction in the combination of these technical features, it is considered as the range described in this specification.

The above examples only express several implementation of the present disclosure, and the descriptions are more specific and detailed, but they should not be understood as a limitation on the patent scope of the present disclosure. It should be pointed out that for those of ordinary skill in the art, without departing from the concept of the present disclosure, several modifications and improvements can be made, and these all fall within the protection scope of the present disclosure. Therefore, the protection scope of the present disclosure should be subject to the appended claims.

What is claimed is:

1. An optical system comprising, in order from an object side to an image side along an optical axis of the optical system:
a first lens with a positive refractive power and having an object-side surface which is convex;
a second lens with a negative refractive power and having an image-side surface which is concave near the optical axis;
a third lens with a refractive power and having an object-side surface which is convex near the optical axis;
a fourth lens with a refractive power and having an object-side surface and an image-side surface which are aspheric surfaces;
a fifth lens with a positive refractive power and having an object-side surface which is concave near a periphery, the object-side surface and an image-side surface of the fifth lens being aspheric surfaces, and at least one of the object-side surface and the image-side surface of the fifth lens having at least one inflection point; and
a sixth lens with a negative refractive power and having an object-side surface which is convex near the optical axis and an image-side surface which is concave near the optical axis, the object-side surface and the image-side surface of the sixth lens being aspheric surfaces, and at least one of the object-side surface and the image-side surface of the sixth lens having at least one inflection point.

2. The optical system of claim 1, wherein the optical system satisfies the following expression:

|SAG41|/|SAG42|<20.0;
wherein SAG41 represents a sagittal depth at a maximum effective aperture of the object-side surface of the fourth lens, and SAG42 represents a sagittal depth at a maximum effective aperture of the image-side surface of the fourth lens.

3. The optical system of claim 1, wherein the optical system satisfies the following expression:
2.2<(CT2+CT3+CT4)/(CT23+CT34)≤8.5;
wherein CT2 represents a thickness of the second lens on the optical axis, CT3 represents a thickness of the third lens on the optical axis, CT4 represents a thickness of the fourth lens on the optical axis, CT23 represents a distance from the image-side surface of the second lens to the object-side surface of the third lens on the optical axis, and CT34 represents a distance from an image-side surface of the third lens to the object-side surface of the fourth lens on the optical axis.

4. The optical system of claim 1, wherein the optical system satisfies the following expression:
0.35<f/|f3|+f/|f4|<0.8;
wherein f represents an effective focal length of the optical system, f3 represents an effective focal length of the third lens, and f4 represents an effective focal length of the fourth lens.

5. The optical system of claim 1, wherein the optical system satisfies the following expression:

|SAG61/CT6 [symbol] 1.8;
wherein SAG61 represents a sagittal depth at an effective aperture of the object-side surface of the sixth lens, and CT6 represents a thickness of the sixth lens on the optical axis.

6. The optical system of claim 1, wherein the optical system satisfies the following expression:
0.2<∥R51|−|R52∥/(|R51|+|R52|) [symbol] 0.8;
wherein R51 represents a radius of curvature of the object-side surface of the fifth lens at the optical axis, and R52 represents a radius of curvature of the image-side surface of the fifth lens at the optical axis.

7. The optical system of claim 1, wherein the optical system satisfies the following expression:
f123/|f56| [symbol] 0.36;
wherein f123 represent an effective total focal length of the first lens, the second lens, and the third lens, and f56 represents an effective total focal length of the fifth lens and the sixth lens.

8. The optical system of claim 1, wherein the optical system satisfies the following expression:
0.60 mm<(CT1+BF)/FNO [symbol] 0.85 mm;
wherein CT1 represents a thickness of the first lens on the optical axis, BF represents an axial distance from a farthest point on the image-side surface of the sixth lens to an imaging surface, and FNO represents an F-number of the optical system.

9. The optical system of claim 1, wherein the optical system satisfies the following expression:
6.1<|f3|/n3<22.7;
wherein f3 represents an effective focal length of the third lens, and n3 represents a refractive index of a material of the third lens under a wavelength of 587.6 nm.

10. The optical system of claim 1, wherein the optical system satisfies the following expression:
ET34/ImgH [symbol] 0.12;
wherein ET34 represents an axial distance from a point where the image-side surface of the third lens has a maximum effective aperture to a point where the object-side surface of the fourth lens has a maximum effective aperture, and ImgH represents half of a diagonal length of an effective imaging region on an imaging surface of the optical system.

11. A lens module, comprising:
a lens barrel;
an optical system comprising, in order from an object side to an image side along an optical axis of the optical system:
a first lens with a positive refractive power and having an object-side surface which is convex;
a second lens with a negative refractive power and having an image-side surface which is concave near the optical axis;
a third lens with a refractive power and having an object-side surface which is convex near the optical axis;
a fourth lens with a refractive power and having an object-side surface and an image-side surface which are aspheric surfaces;
a fifth lens with a positive refractive power and having an object-side surface which is concave near a periphery, the object-side surface and an image-side surface of the fifth lens being aspheric surfaces, and at least one of the object-side surface and the image-side surface of the fifth lens having at least one inflection point; and
a sixth lens with a negative refractive power and having an object-side surface which is convex near the optical axis and an image-side surface which is concave near the optical axis, the object-side surface and the image-side surface of the sixth lens being aspheric surfaces, and at least one of the object-side surface and the image-side surface of the sixth lens having at least one inflection point;
wherein the first lens to the sixth lens of the optical system are installed inside the lens barrel; and
an electronic photosensitive element disposed at the image side of the optical system and configured to convert light of an object incident to the electronic photosensitive element through the first lens to the sixth lens to an electrical signal of an image.

12. The lens module of claim 11, wherein the optical system satisfies the following expression:

|SAG41|/|SAG42|<20.0;
wherein SAG41 represents a sagittal depth at a maximum effective aperture of the object-side surface of the fourth lens, and SAG42 represents a sagittal depth at a maximum effective aperture of the image-side surface of the fourth lens.

13. The lens module of claim 11, wherein the optical system satisfies the following expression:
2.2<(CT2+CT3+CT4)/(CT23+CT34) [symbol] 8.5;
wherein CT2 represents a thickness of the second lens on the optical axis, CT3 represents a thickness of the third lens on the optical axis, CT4 represents a thickness of the fourth lens on the optical axis, CT23 represents a distance from the image-side surface of the second lens to the object-side surface of the third lens on the optical axis, and CT34 represents a distance from an image-side surface of the third lens to the object-side surface of the fourth lens on the optical axis.

14. The lens module of claim 11, wherein the optical system satisfies the following expression:
0.35<f/|f3|+f/|f4|<0.8;
wherein f represents an effective focal length of the optical system, f3 represents an effective focal length of the third lens, and f4 represents an effective focal length of the fourth lens.

15. The lens module of claim 11, wherein the optical system satisfies the following expression:

|SAG61/CT6 [symbol] 1.8;
wherein SAG61 represents a sagittal depth at an effective aperture of the object-side surface of the sixth lens, and CT6 represents a thickness of the sixth lens on the optical axis.

16. An electronic device, comprising a housing and a lens module, wherein the lens module is disposed inside the housing, and the lens module comprising:
a lens barrel;
an optical system comprising, in order from an object side to an image side along an optical axis of the optical system:
a first lens with a positive refractive power and having an object-side surface which is convex;
a second lens with a negative refractive power and having an image-side surface which is concave near the optical axis;
a third lens with a refractive power and having an object-side surface which is convex near the optical axis;
a fourth lens with a refractive power and having an object-side surface and an image-side surface which are aspheric surfaces;
a fifth lens with a positive refractive power and having an object-side surface which is concave near a periphery, the object-side surface and an image-side surface of the fifth lens being aspheric surfaces, and at least one of the object-side surface and the image-side surface of the fifth lens having at least one inflection point; and
a sixth lens with a negative refractive power and having an object-side surface which is convex near the optical axis and an image-side surface which is concave near the optical axis, the object-side surface and the image-side surface of the sixth lens being aspheric surfaces, and at least one of the object-side surface and the image-side surface of the sixth lens having at least one inflection point;
wherein the first lens to the sixth lens of the optical system are installed inside the lens barrel; and
an electronic photosensitive element disposed at the image side of the optical system and configured to convert light of an object incident to the electronic photosensitive element through the first lens to the sixth lens to an electrical signal of an image.

17. The electronic device of claim 16, wherein the optical system satisfies the following expression:

|SAG41|/|SAG42|<20.0;
wherein SAG41 represents a sagittal depth at a maximum effective aperture of the object-side surface of the fourth lens, and SAG42 represents a sagittal depth at a maximum effective aperture of the image-side surface of the fourth lens.

18. The electronic device of claim 16, wherein the optical system satisfies the following expression:
2.2<(CT2+CT3+CT4)/(CT23+CT34) [symbol] 8.5;
wherein CT2 represents a thickness of the second lens on the optical axis, CT3 represents a thickness of the third lens on the optical axis, CT4 represents a thickness of the fourth lens on the optical axis, CT23 represents a distance from the image-side surface of the second lens to the object-side surface of the third lens on the optical axis, and CT34 represents a distance from an image-side surface of the third lens to the object-side surface of the fourth lens on the optical axis.

19. The electronic device of claim 16, wherein the optical system satisfies the following expression:
0.35<f/|f3|+f/|f4|<0.8;
wherein f represents an effective focal length of the optical system, f3 represents an effective focal length of the third lens, and f4 represents an effective focal length of the fourth lens.

20. The electronic device of claim 16, wherein the optical system satisfies the following expression:

|SAG61/CT6| [symbol] 1.8;
wherein SAG61 represents a sagittal depth at an effective aperture of the object-side surface of the sixth lens, and CT6 represents a thickness of the sixth lens on the optical axis.
